(19) United States
(12) Patent Application Publication
(10) Pub. No.: US 2016/0116197 A1
(43) Pub. Date: Apr. 28, 2016

(54) REFRIGERATION CYCLE DEVICE

(71) Applicant: DENSO CORPORATION, Kariya-city, Aichi-pref (JP)

(72) Inventors: Masayuki TAKEUCHI, Kariya-city (JP); Takashi YAMANAKA, Kariya-city (JP)

(21) Appl. No.: 14/890,926

(22) PCT Filed: May 12, 2014
(86) PCT No.: PCT/JP2014/002484

§ 371 Date: Nov. 13, 2015

(30) Foreign Application Priority Data
May 22, 2013 (JP) 2013-107766

(51) Int. Cl. F25B 47/02; B60H 1/00; B60H 1/22

(52) U.S. Cl. CPC F25B 47/02; B60H 1/22; B60H 1/00278

(57) ABSTRACT

When a defrosting of an exterior heat exchanger is performed, a refrigeration cycle device switches to a refrigerant circuit, in which a refrigerant discharged from a compressor dissipates its heat at an interior condenser and the exterior heat exchanger, the refrigerant dissipating the heat at the interior condenser and the exterior heat exchanger is decompressed by a battery expansion valve, and then the refrigerant decompressed by the battery expansion valve evaporates at a battery heat exchanger to be drawn into the compressor. Thus, the heat absorbed by the refrigerant from a secondary battery via a battery ventilation air can be used to defrost the exterior heat exchanger, while sufficiently heating the interior ventilation air at the interior condenser.

### CROSS REFERENCE TO RELATED APPLICATION

The application is based on a Japanese Patent Application No. 2013-107766 filed on May 22, 2013, the contents of which are incorporated herein by reference in its entirety.

### FIELD OF THE INVENTION

The present disclosure relates to a refrigeration cycle device used to adjust the temperature of a battery.

### BACKGROUND ART

Conventionally, there are known refrigeration cycle devices that are applied to air conditioners for heating a space to be air-conditioned. This kind of refrigeration cycle device is designed to perform air-heating of the space to be air-conditioned by exchanging heat between a high-temperature refrigerant discharged from a compressor and ventilation air (fluid to be heat-exchanged) to be blown into the space to be air-conditioned, thereby heating the ventilation air.

Such a refrigeration cycle device further includes an exterior heat exchanger that exchanges heat between the refrigerant and the outside air. During an air heating operation in which the space to be air-conditioned is heated, the refrigerant heats the ventilation air with heat absorbed from the outside air when the refrigerant evaporates at the exterior heat exchanger. Therefore, if a refrigerant evaporation temperature is lower than the frost formation temperature (specifically, 0° C.) at the exterior heat exchanger during the air heating operation, frost might be formed on the exterior heat exchanger.

The formation of frost would close an outside air passage of the exterior heat exchanger with the frost, drastically degrading the heat exchange performance of the exterior heat exchanger. For this reason, there are some proposed types of refrigeration cycle devices that are designed to perform a defrost operation to remove frost when it is formed on the exterior heat exchanger.

For example, a refrigeration cycle device to be applied to a vehicle air conditioner, as disclosed in Patent Document 1, executes a defrost operation when frost is formed on an exterior heat exchanger. The defrost operation involves switching to a refrigerant circuit that allows a high-temperature refrigerant discharged from a compressor to flow into an exterior heat exchanger, thereby melting and removing frost formed on the exterior heat exchanger with heat contained in the high-temperature refrigerant.

Further, during the defrost operation, the refrigeration cycle device of Patent Document 1 switches to a refrigerant circuit that allows the refrigerant flowing out of the exterior heat exchanger to flow into an interior heat exchanger positioned on the interior side, thereby exchanging heat between the refrigerant flowing out of the exterior heat exchanger and the ventilation air to be blown into the vehicle interior as the space to be air-conditioned. In this way, even during execution of the defrost operation, the refrigeration cycle device of Patent Document 1 proposes to achieve the air-heating of the vehicle interior by heating the ventilation air by means of the interior heat exchanger.

### RELATED ART DOCUMENT

### Patent Document

[Patent Document 1] Japanese Unexamined Patent Application Publication No. 2003-42604

### SUMMARY OF THE INVENTION

In the refrigeration cycle device disclosed in Patent Document 1, however, the refrigerant flowing out of the exterior heat exchanger is decompressed to a pressure equal to or lower than the pressure capacity of the interior heat exchanger in the defrost operation, and then permitted to flow into the interior heat exchanger. Thus, during the defrost operation, the temperature of the refrigerant flowing into the interior heat exchanger might be decreased, as compared to during the air heating operation.

Further, in the refrigeration cycle device of Patent Document 1, in the defrost operation, the refrigerant flowing out of the interior heat exchanger is drawn into the compressor via an internal heat exchanger that exchanges heat with a refrigerant in a cycle (specifically, a refrigerant flowing out of the exterior heat exchanger). Thus, in the defrost operation, to heat the ventilation air at the interior heat exchanger, the refrigeration cycle device can use only the heat in an amount that is determined by subtracting the amount of heat required for defrosting the exterior heat exchanger from a compression workload of the compressor and then adding the amount of heat absorbed from the refrigerant in the cycle thereto.

As a result, in the refrigeration cycle device of Patent Document 1, during execution of the defrost operation, the interior heat exchanger might reduce its heating capacity for the ventilation air, failing to achieve adequate air-heating of the vehicle interior.

In view of the foregoing matter, it is an object of the present disclosure to provide a refrigeration cycle device that can suppress the reduction in heating capacity for a fluid to be heat-exchanged even during execution of the defrost operation of an exterior heat exchanger.

To achieve the above object, according to an aspect of the present disclosure, a refrigeration cycle device includes: a compressor that compresses and discharges a refrigerant; a heating heat exchanger that exchanges heat between a fluid to be heat-exchanged and the refrigerant discharged from the compressor to heat the fluid to be heat-exchanged; an exterior heat exchanger that exchanges heat between the refrigerant and outside air; an exterior-device decompression device that decompresses the refrigerant to flow into the exterior heat exchanger; a battery heat exchanger that exchanges heat between a battery and either one of the refrigerant discharged from the compressor and the refrigerant flowing out of the exterior heat exchanger to adjust a battery temperature of the battery; a battery decompression device that decompresses the refrigerant to flow into the battery heat exchanger; and a refrigerant circuit switching portion that switches a refrigerant circuit for the refrigerant circulating through a cycle. The refrigerant circuit switching portion switches to a refrigerant circuit in which the refrigerant dissipating heat at least in the heating heat exchanger is decompressed by the exterior-device decompression device and is evaporated at the exterior heat exchanger, in a fluid heating operation for heating the fluid to be heat-exchanged. Furthermore, the refrigerant circuit switching portion switches to another refrigerant circuit in which the refrigerant dissipating heat in the heating heat exchanger and the exterior heat exchanger is decompressed by the battery decompression device, and is evaporated at the battery heat exchanger, in a defrost operation for defrosting the exterior heat exchanger.

Thus, when frost is formed on the exterior heat exchanger due to execution of the heating operation, the refrigerant circuit switching portion switches from the refrigerant circuit for the heating operation to the refrigerant circuit for the defrost operation, thereby enabling defrosting of the exterior heat exchanger.

Further, in the refrigerant circuit for the defrost operation, the refrigeration cycle can be configured in which a refrigerant discharged from the compressor is allowed to dissipate its heat at the heating heat exchanger and the exterior heat exchanger, the refrigerant dissipating its heat at the heating heat exchanger and the exterior heat exchanger is decompressed by the battery decompression device, and then the refrigerant decompressed by the battery decompression device is allowed to evaporate at the battery heat exchanger to be drawn into the compressor.

Therefore, in the defrost operation, the high-temperature refrigerant discharged from the compressor can be allowed to flow into the heating heat exchanger and the exterior heat exchanger. Further, to defrost the exterior heat exchanger while heating the fluid to be heated by the heating heat exchanger in the defrost operation, the refrigeration cycle device can utilize the amount of heat obtained by adding a compression workload of the compressor to an amount of heat absorbed from the battery in evaporating the low-pressure refrigerant at the battery heat exchanger.

Here, the battery has so relatively large heat capacity that it can store therein heat required to sufficiently heat the fluid to be heated as well as heat required to defrost the exterior heat exchanger. Thus, in the defrost operation, the heat absorbed from the battery can be used not only to defrost the exterior heat exchanger, but also to sufficiently heat the fluid to be heat-exchanged at the heating heat exchanger.

That is, the refrigeration cycle device can be provided which can suppress the reduction in heating capacity for the fluid to be heat-exchanged even during execution of the defrost operation of an exterior heat exchanger.

The term “exchanging heat between the refrigerant and the battery” as used in the present disclosure means not only the direct heat exchange between the refrigerant and the battery, but also the indirect heat exchange between the refrigerant and the battery via the heat medium, such as a fluid or the like.

### BRIEF DESCRIPTION OF DRAWINGS

FIG. 1 is an entire configuration diagram showing a refrigerant flow in an air cooling operation mode of a refrigeration cycle device according to a first embodiment.

FIG. 2 is an entire configuration diagram showing a refrigerant flow in an air-cooling device-cooling operation mode of the refrigeration cycle device in the first embodiment.

FIG. 3 is an entire configuration diagram showing a refrigerant flow in a device cooling operation mode of the refrigeration cycle device in the first embodiment.

FIG. 4 is an entire configuration diagram showing a refrigerant flow in an air heating operation mode of the refrigeration cycle device in the first embodiment.

FIG. 5 is an entire configuration diagram showing a refrigerant flow in an air-heating device-heating operation mode of the refrigeration cycle device in the first embodiment.

FIG. 6 is an entire configuration diagram showing a refrigerant flow in a device heating operation mode of the refrigeration cycle device in the first embodiment.

FIG. 7 is an entire configuration diagram showing a refrigerant flow in a defrost operation mode of the refrigeration cycle device in the first embodiment.

FIG. 8 is an explanatory diagram for explaining output characteristics of a secondary battery (lithium-ion battery) in the first embodiment.

FIG. 9 is a Mollier chart showing the state of refrigerant in the defrost operation mode of the refrigeration cycle device in the first embodiment.

FIG. 10 is a time chart showing changes in battery temperature of the refrigeration cycle device or the like in the first embodiment.

FIG. 11 is a time chart showing changes in battery temperature of a refrigeration cycle device or the like according to a second embodiment.

FIG. 12 is an entire configuration diagram showing a refrigerant flow in a device heating operation mode of a refrigeration cycle device according to a third embodiment.

FIG. 13 is an entire configuration diagram showing a refrigerant flow in a defrost operation mode of the refrigeration cycle device in the third embodiment.

FIG. 14 is a time chart showing changes in battery temperature of a refrigeration cycle device or the like in the third embodiment.

FIG. 15 is an entire configuration diagram of a refrigeration cycle device according to a fourth embodiment.

FIG. 16 is an entire configuration diagram of a refrigeration cycle device according to a fifth embodiment.

FIG. 17 is an entire configuration diagram showing a refrigerant flow in an air cooling operation mode of a refrigeration cycle device according to a sixth embodiment.

FIG. 18 is an entire configuration diagram showing a refrigerant flow in an air-cooling device-cooling operation mode of the refrigeration cycle device in the sixth embodiment.

FIG. 19 is an entire configuration diagram showing a refrigerant flow in a device cooling operation mode of the refrigeration cycle device in the sixth embodiment.

FIG. 20 is an entire configuration diagram showing a refrigerant flow in an air heating operation mode of the refrigeration cycle device in the sixth embodiment.

FIG. 21 is an entire configuration diagram showing a refrigerant flow in an air-heating device-heating operation mode of the refrigeration cycle device in the sixth embodiment.

FIG. 22 is an entire configuration diagram showing a refrigerant flow in a device heating operation mode of the refrigeration cycle device in the sixth embodiment.

FIG. 23 is an entire configuration diagram showing a refrigerant flow in a defrost operation mode of the refrigeration cycle device in the sixth embodiment.

### DESCRIPTION OF EMBODIMENTS

### First Embodiment

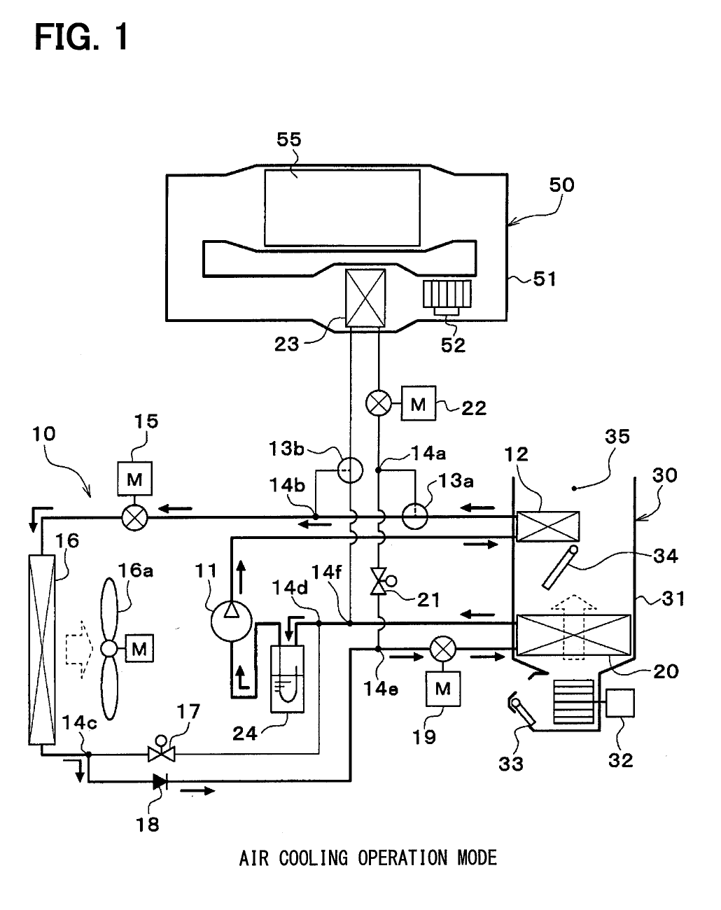

A first embodiment of the present disclosure will be described below with reference to FIGS. 1 to 10. In this embodiment, a refrigeration cycle device 10 according to the present disclosure is applied to an electric vehicle that is designed to obtain a driving force for traveling from a traveling electric motor. Further, in the electric vehicle of this embodiment, the refrigeration cycle device 10 is used to control air conditioning (i.e., air-cooling and air-heating) of a vehicle interior, and also to adjust the temperature of (i.e., heating and cooling) a secondary battery 55 which serves as an electric storage device for storing therein electric power to be supplied to the traveling electric motor.

More specifically, the refrigeration cycle device 10 performs a function of adjusting the temperature of interior ventilation air to be blown into a vehicle compartment, and another function of adjusting the temperature of battery ventilation air to be blown toward the secondary battery 55. Further, the refrigeration cycle device 10 can be configured to switch among refrigeration circuits. As shown in FIGS. 1 to 7, the refrigeration cycle device 10 switches the refrigeration circuit to adjust the temperatures of the interior ventilation air and the battery ventilation air.

A compressor 11 among the components of the refrigeration cycle device 10 is positioned in the bonnet of the vehicle, and is to suck, compress, and discharge the refrigerant in the refrigeration cycle device 10. The compressor is an electric compressor that rotatably drives a fixed displacement compression mechanism with a fixed discharge capacity by use of an electric motor. The electric motor of the compressor 11 has its operation (the number of revolutions) controlled by a control signal output from a controller to be described later.

The refrigeration cycle device 10 employs a hydrofluorocarbon (HFC)-based refrigerant (for example, R134a) as the refrigerant, and forms a vapor compression type subcritical refrigeration cycle whose high-pressure side refrigerant pressure does not exceed the critical pressure of the refrigerant. Obviously, a hydrofluoro-olefin (HFO)-based refrigerant (for example, R1234yf) or the like may be used as the refrigerant. Further, refrigerating machine oil for lubricating the compressor 11 is mixed into the refrigerant, and a part of the refrigerating machine oil circulates through the cycle together with the refrigerant.

The discharge port side of the compressor 11 is coupled to a refrigerant inlet side of an interior condenser 12. The interior condenser 12 is disposed in a casing 31 that forms an air passage for the interior ventilation air in an interior air conditioning unit 30. The interior condenser 12 is a heating heat exchanger that exchanges heat between a refrigerant discharged from the compressor 11 and the interior ventilation air passing through an interior evaporator 20 to be described later, thereby heating the interior ventilation air. The details of the interior air conditioning unit 30 will be described later.

A refrigerant outlet side of the interior condenser 12 is connected to a first three-way valve 13a. The first three-way valve 13a is an electric three-way valve having its operation controlled by a control voltage output from the controller.

More specifically, the first three-way valve 13a is adapted to switch between a refrigerant circuit that connects the refrigerant outlet side of the interior condenser 12 and one of refrigerant inflow ports of a first three-way joint 14a, and another refrigerant circuit that connects the refrigerant outlet side of the interior condenser 12 and one of refrigerant inflow ports of a second three-way joint 14b. Thus, the first three-way valve 13a serves as a refrigerant circuit switching portion that switches the refrigerant circuit for circulation of the refrigerant through the cycle.

The first three-way joint 14a has a joint structure with three inflow/outflow ports. Examples of the first three-way joint suitable for use can include an arrangement of a plurality of pipes bonded together, a metal or resin block with a plurality of refrigerant passages formed therein, and the like. Each of the second three-way joint 14b and third to sixth three-way joints 14c to 14f to be described later also has substantially the same basic structure as that of the first three-way joint 14a.

In the first three-way joint 14a, two of three inflow/outflow ports are used as refrigerant inflow ports, and one remaining inflow/outflow port is used as a refrigerant outflow port. Specifically, one refrigerant inflow port of the first three-way joint 14a is connected to one refrigerant inflow/outflow port of the first three-way valve 13a. The other refrigerant inflow port of the first three-way joint 14a is connected to the outlet side of a battery opening/closing valve 21 to be described later. The refrigerant outflow port of the first three-way joint 14a is connected to the inlet side of a battery expansion valve 22 to be described later.

In the second three-way joint 14b, like the first three-way joint 14a, two of three inflow/outflow ports are used as refrigerant inflow ports, and one remaining inflow/outflow port is used as a refrigerant outflow port. Specifically, one refrigerant inflow port of the second three-way joint 14b is connected to another refrigerant inflow/outflow port of the first three-way valve 13a. The other refrigerant inflow port of the second three-way joint 14b is connected to one refrigerant inflow/outflow port of a second three-way valve 13b to be described later. Further, the refrigerant outflow port of the second three-way joint 14b is connected to the inlet side of an air-heating expansion valve 15.

Therefore, the first tree-way valve 13a substantially switches between a refrigerant circuit that connects the refrigerant outlet side of the interior condenser 12 to the inlet side of the battery expansion valve 22, and another refrigerant circuit that connects the refrigerant outlet side of the interior condenser 12 to the inlet side of the air-heating expansion valve 15.

The air-heating expansion valve 15 is a decompression device for the exterior device that decompresses the refrigerant flowing from the second three-way joint 14b into an exterior heat exchanger 16 when performing air-heating of the vehicle interior by heating the interior ventilation air, and the like.

More specifically, the air-heating expansion valve 15 is an electric expansion valve that includes a valve body having an adjustable throttle opening, and an electric actuator having a stepping motor designed to change the throttle opening of the valve body. The air-heating expansion valve 15 has its operation controlled by a control signal output from the controller. The air-heating expansion valve 15 is comprised of a variable throttle mechanism with a fully opening function that serves as a mere refrigerant passage by fully opening its throttle opening without almost exhibiting any refrigerant decompressing effect.

The outlet side of the air-heating expansion valve 15 is connected to the refrigerant inlet side of the exterior heat exchanger 16. The exterior heat exchanger 16 is disposed in the bonnet and serves to exchange heat between the refrigerant circulating through the inside of the exterior heat exchanger and the outside air blown from a blower fan 16a. As such an exterior heat exchanger 16, a fin and tube heat exchanger or the like can be used.

More specifically, the exterior heat exchanger 16 serves as an evaporator that exhibits a heat absorption effect by evaporating a low-pressure refrigerant when performing air-heating of the vehicle interior by heating the interior ventilation air or the like, and also serves as a radiator that dissipates heat from a high-pressure refrigerant when performing air-cooling of the vehicle interior by cooling the interior ventilation air or the like. The blower fan 16a is an electric blower whose operating ratio, that is, whose number of revolutions (volume of ventilation air) is controlled by a control voltage output from the controller.

The refrigerant outlet side of the exterior heat exchanger 16 is connected to the third three-way joint 14c. In the third three-way joint 14c, one of three inflow/outflow ports is used as a refrigerant inflow port, and two remaining inflow/outflow ports are used as refrigerant outflow ports. One of the refrigerant outflow ports of the third three-way joint 14c is connected to one of the refrigerant inflow port of the fourth three-way joint 14d via an air-heating opening/closing valve 17. The other refrigerant outflow port of the third three-way joint 14c is connected to a refrigerant inflow port of the fifth three-way joint 14e via a check valve 18.

The air-heating opening/closing valve 17 is an opening/closing device that opens and closes the refrigerant flow path leading from the third three-way joint 14c to the fourth three-way joint 14d. The air-heating opening/closing valve 17 is comprised of an electromagnetic valve having its opening and closing operations controlled by a control voltage output from the controller. The fourth three-way joint 14d has three inflow/outflow ports, two of which serve as the refrigerant inflow ports, and one of which serves as the refrigerant outflow port. The refrigerant outflow port of the fourth three-way joint 14d is connected to an accumulator 24 to be described later.

Thus, when the air-heating opening/closing valve 17 is open, it can perform switching to a refrigerant circuit that allows the refrigerant flowing out of the exterior heat exchanger 16 to flow into the accumulator 24 via the third three-way joint 14c and the fourth three-way joint 14d. When the air-heating opening/closing valve 17 is closed, it can perform switching to a refrigerant circuit that allows the refrigerant flowing out of the exterior heat exchanger 16 to flow into the side of the fifth three-way joint 14e via the check valve 18. That is, the air-heating opening/closing valve 17 constitutes the refrigerant circuit switching portion.

The check valve 18 allows the refrigerant only to flow from a side of the third three-way joint 14c (on the refrigerant outlet side of the exterior heat exchanger 16) to a side of the fifth three-way joint 14e (the inlet side of an air-cooling expansion valve 19 or the inlet side of a battery opening/closing valve 21).

In the fifth three-way joint 14e, one of three inflow/outflow ports is used as a refrigerant inflow port, and two remaining inflow/outflow ports are used as refrigerant outflow ports. One of the refrigerant outflow ports of the fifth three-way joint 14e is connected to a side of the refrigerant inlet of the interior evaporator 20 via the air-cooling expansion valve 19. The other refrigerant outflow port of the fifth three-way joint 14e is connected to the other refrigerant inflow port of the first three-way joint 14a described above via the battery opening/closing valve 21.

The air-cooling expansion valve 19 is an electric expansion valve with the same structure as the air-heating expansion valve 15. The air-cooling expansion valve 19 is a decompression device for air-cooling that decompresses the refrigerant flowing out of the exterior heat exchanger 16 into the interior evaporator 20 when executing air-cooling of the vehicle interior by cooling the interior ventilation air. The air-cooling expansion valve 19 is comprised of a variable throttle mechanism with a complete closing function that can close a refrigerant flow path leading from the fifth three-way joint 14e to the refrigerant inlet side of the interior evaporator 20 by completely closing the throttle opening of the valve body.

Thus, the air-cooling expansion valve 19 can open and close a refrigerant flow path leading from the fifth three-way joint 14e to the refrigerant inlet side of the interior evaporator 20, thereby switching between a refrigerant circuit for inflow of the refrigerant from the fifth three-way joint 14e into the interior evaporator 20 and another refrigerant circuit for preventing the refrigerant from flowing into the interior evaporator 20. That is, the air-cooling expansion valve 19 has a function of the decompression device as well as another function of the refrigerant circuit switching portion.

The interior evaporator 20 is disposed on the air flow upstream side of the interior condenser 12 in the casing 31 of the interior air conditioning unit 30. The interior evaporator 20 is a cooling heat exchanger that exchanges heat between the refrigerant decompressed by the air-cooling expansion valve 19 and the interior ventilation air to thereby cool the interior ventilation air. The refrigerant outlet side of the interior evaporator 20 is connected to the other refrigerant inflow port of the fourth three-way joint 14d via the sixth three-way joint 14f.

The sixth three-way joint 14f has three inflow/outflow ports, two of which serve as the refrigerant inflow ports, and one of which serves as the refrigerant outflow port. The other refrigerant inflow port of the sixth three-way joint 14f is connected to one refrigerant inflow/outflow port of the second three-way valve 13b to be described later. Note that regarding the three-way joint directly connected to the circuit, such as the fourth three-way joint 14d and the sixth three-way joint 14f, a four-way joint having four refrigerant inflow/outflow ports may be used in place of these two three-way joints.

The battery opening/closing valve 21 connected to the other refrigerant outflow port of the fifth three-way joint 14e is an electromagnetic valve having the same structure as that of the air-heating opening/closing valve 17. The battery opening/closing valve 21 is an opening/closing device that opens and closes the refrigerant flow path leading from the fifth three-way joint 14e to the first three-way joint 14a.

Thus, when the battery opening/closing valve 21 is open, it can perform switching to a refrigerant circuit that allows the refrigerant flowing out of the exterior heat exchanger 16 to flow into the side of the battery expansion valve 22 via the fifth three-way joint 14e and the first three-way joint 14a. When the battery opening/closing valve 21 is closed, it can perform switching to another refrigerant circuit that allows the refrigerant flowing out of the exterior heat exchanger 16 to flow into the side of the air-cooling expansion valve 19. That is, the battery opening/closing valve 21 constitutes the refrigerant circuit switching portion.

The battery expansion valve 22 is an electric expansion valve with a full opening function that has the same structure as the air-heating expansion valve 15. The battery expansion valve 22 is a battery decompression device that decompresses the refrigerant flowing out of the interior condenser 12 or exterior heat exchanger 16 into the battery heat exchanger 23 when adjusting the temperature of the secondary battery 55 by adjusting the temperature of the battery ventilation air. The outlet side of the battery expansion valve 22 is connected to the refrigerant inlet side of the battery heat exchanger 23 disposed in a battery pack 50.

The battery heat exchanger 23 is disposed in the battery pack 50 that forms an air passage for the battery ventilation air to be blown toward the secondary battery 55. The battery heat exchanger 23 is to adjust the temperature of the battery ventilation air by exchanging heat between the refrigerant flowing there through and the battery ventilation air. The details of the battery pack 50 will be described later.

The refrigerant outlet side of the battery heat exchanger 23 is connected to the other refrigerant inflow port of the second three-way valve 13b. The second three-way valve 13b has the same basic structure as that of the first three-way valve 13a. Specifically, the second three-way valve 13b is adapted to switch between a refrigerant circuit that connects the refrigerant outlet side of the battery heat exchanger 23 and the other refrigerant inflow port of the second three-way joint 14b described above, and another refrigerant circuit that connects the refrigerant outlet side of the battery heat exchanger 23 and the other refrigerant inflow port of the sixth three-way joint 14f.

That is, the second three-way valve 13b constitutes a refrigerant circuit switching portion adapted to substantially switch between a refrigerant circuit that connects the refrigerant outlet side of the battery heat exchanger 23 to the inlet side of the air-heating expansion valve 15, and another refrigerant circuit that connects the refrigerant outlet side of the battery heat exchanger 23 to the inlet side of the accumulator 24.

The accumulator 24 separates the refrigerant flowing into the accumulator itself into gas and liquid-phase refrigerants, and stores therein the separated liquid-phase refrigerant while allowing the separated gas-phase refrigerant to flow into the suction side of the compressor 11. That is, the accumulator 24 has a function of a gas-liquid separator, as well as a function of a refrigerant storage portion for storing therein excessive refrigerant within the cycle in the liquid-phase state.

Next, the interior air conditioning unit 30 will be described below. The interior air conditioning unit 30 is to blow out the interior ventilation air having its temperature adjusted, into the vehicle compartment. The interior air conditioning unit 30 is installed inside a gauge board (instrument panel) at the forefront of the vehicle compartment. The unit 30 accommodates a blower 32, the above-mentioned interior condenser 12, the interior evaporator 20, and the like in the casing 31 forming an outer envelope.

The casing 31 forms therein an air passage for the interior ventilation air. The casing 31 is formed of resin (for example, polypropylene) having some degree of elasticity and excellent strength. An inside/outside air switching portion 33 is disposed on the most upstream side of the interior ventilation air flow in the casing 31 so as to change a ratio of the volume of the inside air introduced into the air passage (i.e., air inside the vehicle compartment) to that of the outside air (i.e., air outside the vehicle compartment).

On the downstream side of air flow of the inside/outside air switching portion 33, the blower 32 is provided for blowing air introduced via the inside/outside air switching portion 33 toward the vehicle interior. The blower 32 is an electric blower that drives a centrifugal multi-blade fan (sirrocco fan) by an electric motor. The blower 32 has the number of revolutions (i.e., air blowing volume) controlled by a control voltage output from the controller.

The interior evaporator 20 and the interior condenser 12 are disposed on the downstream side of the air flow of the blower 32 in that order with respect to the flow of the interior ventilation air. In short, the interior evaporator 20 is disposed on the upstream side in the flow direction of the interior ventilation air with respect to the interior condenser 12.

Further, an air mix door 34 is disposed on the downstream side of the air flow in the interior evaporator 20 and on the upstream side of the air flow in the interior condenser 12. The air mix door 34 adjusts the rate of the volume of the air passing through the interior condenser 12 among the ventilation air having passed through the interior evaporator 20. A mixing space 35 is provided on the downstream side of the air flow in the interior condenser 12 so as to mix the ventilation air heated by exchanging heat with the refrigerant in the interior condenser 12 with the air not heated while bypassing the interior condenser 12.

Openings for blowing the conditioned air mixed in the mixing space 35, into the vehicle interior as a space of interest to be conditioned are disposed on the most downstream side of the air flow in the casing 31. Specifically, the openings include a face air opening for blowing the conditioned air toward the upper body of a passenger in the vehicle compartment, a foot air opening for blowing the conditioned air toward the foot of the passenger, and a defroster air opening for blowing the conditioned air toward the inner side of a front glass of the vehicle (which openings are not shown).

Thus, the air mix door 34 adjusts the rate of the volume of air passing through the interior condenser 12 to thereby adjust the temperature of conditioned air mixed in the mixing space 35, thus controlling the temperature of the conditioned air blown from each opening. That is, the air mix door 34 serves as a temperature adjustment unit adapted to adjust the temperature of the conditioned air to be blown into the vehicle interior. The air mix door 34 is driven by a servo motor (not shown) having its operation controlled by a control signal output from the controller.

A face door for adjusting an opening area of the face air opening is positioned on the upstream side of the air flow of the face air opening; a foot door for adjusting an opening area of the foot air opening is positioned on the upstream side of the air flow of the foot air opening; and a defroster door for adjusting an opening area of the defroster air opening is positioned on the upstream side of the air flow of the defroster air opening (these doors not shown).

The face door, the foot door, and the defroster door serve as opening mode switching portions for switching among opening modes, and are driven via a link mechanism or the like by a servo motor (not shown) having its operation controlled by a control signal output from the controller.

Next, the battery pack 50 will be described below. The battery pack 50 is disposed at the bottom side of the vehicle body between a trunk room and a rear seat at the rear part of the vehicle body. The battery pack 50 includes a metal casing 51 subjected to an electric-insulating treatment (for example, insulating coating), and forms an air passage for circulating and blowing the battery ventilation air, in the casing 51. The battery pack accommodates the blower 52, the above-mentioned battery heat exchanger 23, the secondary battery 55, and the like in the air passage.

The blower 52 is disposed on the upstream side of the air flow of the battery heat exchanger 23. The blower 52 is an electric blower that blows the battery ventilation air toward the battery heat exchanger 23. The blower 52 has the number of revolutions (air blowing volume) controlled by a control voltage output from the controller. Further, the secondary battery 55 is disposed on the downstream side of the air flow of the battery heat exchanger 23. The downstream side of the air flow of the secondary battery 55 communicates with the suction port side of the blower 52.

Thus, once the controller operates the blower 52, the battery ventilation air having its temperature adjusted by the battery heat exchanger 23 is blown to the secondary battery 55, thereby adjusting the temperature of the secondary battery 55. Then, the battery ventilation air having adjusted the temperature of the secondary battery 55 is drawn into the blower 52 to be blown and circulate again toward the battery heat exchanger 23.

More specifically, when the high-pressure refrigerant or the intermediate-pressure refrigerant flows into the battery heat exchanger 23, the battery ventilation air is heated using the high-pressure or intermediate-pressure refrigerant as a heat source, and the heated battery ventilation air is blown to the secondary battery 55, thereby heating the secondary battery 55. Moreover, when the low-pressure refrigerant flows into the battery heat exchanger 23, the battery ventilation air is cooled using the low-pressure refrigerant as a cold heat source, and the cooled battery ventilation air is blown to the secondary battery 55, thereby cooling the secondary battery 55.

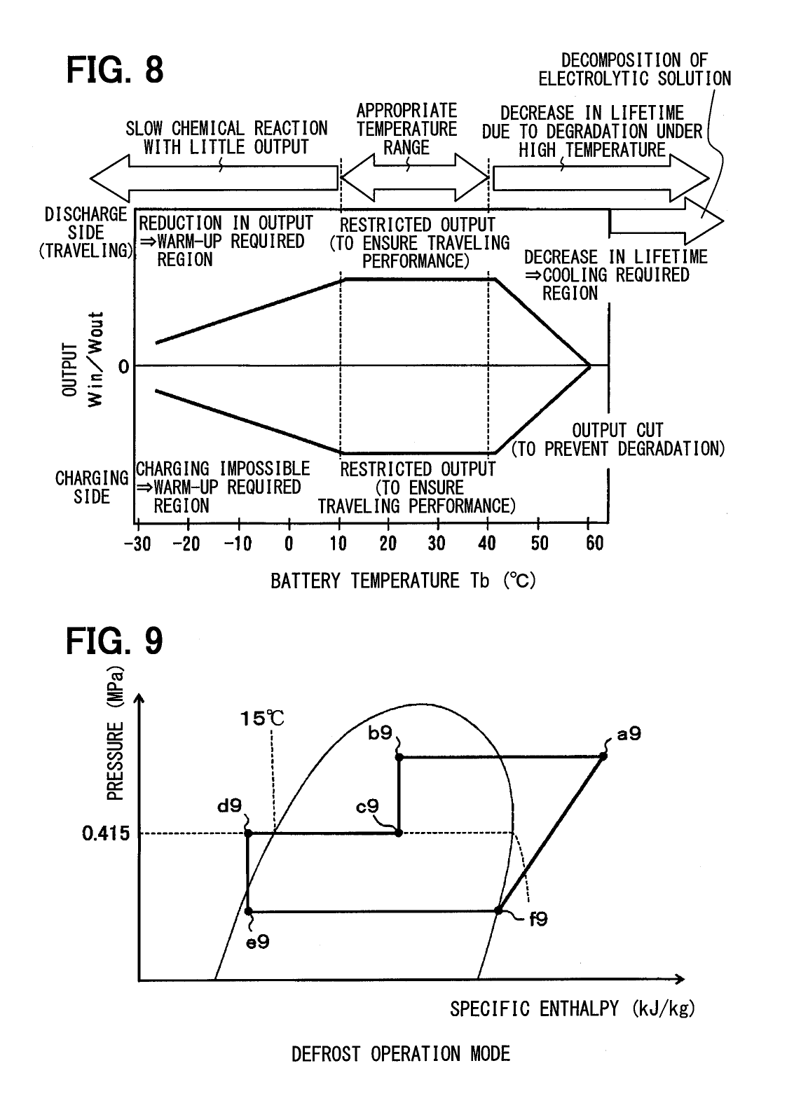

The secondary battery 55 is a lithium-ion battery including a plurality of cells connected in series or in parallel. As shown in FIG. 8, at low temperature of 10° C. or lower, this kind of lithium-ion battery cannot obtain adequate input and output characteristics because a chemical reaction does not progress, or the like. That is, in this embodiment, once the secondary battery 55 becomes at 10° C. or lower, the output from the secondary battery 55 is reduced, which might not allow for the traveling of the vehicle.

On the other hand, this kind of lithium-ion battery tends to be degraded at high temperature. In this embodiment, when a battery temperature Tb of the secondary battery 55 reaches 40° C. or more, the controller is adapted to stop inputting and outputting electric power to prevent degradation of the secondary battery 55. Thus, even when the secondary battery 55 becomes at a high temperature of 40° C. or more, the vehicle cannot travel at all.

That is, in this embodiment, to make effective use of the capacity of the secondary battery 55 to allow for traveling of the vehicle, the secondary battery 55 needs to have its temperature in a range of approximately not less than 10° C. nor more than 40° C. (within an appropriate temperature range). The secondary battery 55 has a high heat capacity for each component of the refrigeration cycle device 10. This embodiment employs the secondary battery 55 having approximately 100 kJ/K.

Next, an electric controller of this embodiment will be described below. The controller is comprised of a known microcomputer, including CPU, ROM, RAM, and the like, and a peripheral circuit thereof. The controller controls the operations of various types of control target devices 11, 13a, 13b, 15, 16a, 17, 19, 21, 22, 32, 52, and the like which are connected to the output side by performing various kinds of computations and processing based on control programs stored in the ROM.

A group of various control sensors is connected to the input side of the controller. The group of sensors includes an inside air sensor that detects a vehicle interior temperature Tr, an outside air sensor that detects an outside air temperature Tam, a solar radiation sensor that detects a solar radiation amount As in the vehicle interior, and an evaporator temperature sensor that detects a blown air temperature (evaporator temperature) Tefin at the interior evaporator 20. The group of sensors also includes a discharge pressure sensor that detects a high-pressure side refrigerant pressure Pd of a high-pressure refrigerant discharged from the compressor 11, a discharge temperature sensor that detects a high-pressure side refrigerant temperature Td of the high-pressure refrigerant discharged from the compressor 11, an exterior device temperature sensor that detects the refrigerant temperature (exterior device temperature) Ts in the exterior heat exchanger 16, and a ventilation air temperature sensor that detects a ventilation air temperature TAV of air blown from the mixing space 35 into the vehicle interior. The group of sensors further includes a battery temperature sensor serving as a temperature detector for detecting a battery temperature Tb as the temperature of the secondary battery 55.

Note that the evaporator temperature sensor of this embodiment detects, specifically, the temperature of heat exchanging fins of the interior evaporator 20. Obviously, the evaporator temperature sensor suitable for use may be a temperature detector for detecting the temperature of any other part of the interior evaporator 20, or a temperature detector for directly detecting the temperature of the refrigerant itself circulating through the interior evaporator 20. The same goes for the exterior device temperature sensor.

The secondary battery 55 has the high capacity for each component of the refrigeration cycle device 10, and is comprised of a combination of cells. Thus, the secondary battery 55 tends to have the temperature distribution. In this embodiment, a plurality of temperature detectors is used to detect the surface temperatures of a plurality of cells included in the secondary battery 55 to thereby define an average of detected values obtained from the plurality of temperature detectors as the battery temperature Tb.

In this embodiment the ventilation air temperature sensor is provided for detecting the ventilation air temperature TAV. Instead of this, the ventilation air temperature TAV suitable for use may be a value calculated based on the evaporator temperature Tefin, the high-pressure side refrigerant temperature Td, and the like.

An operation panel (not shown) is disposed near an instrument board at the front of the vehicle compartment, and coupled to the input side of the controller. Operation signals are input from various types of operation switches provided on the operation panel. Various operation switches provided on the operation panel include an air-conditioning operation switch for requesting air conditioning of a vehicle interior, a vehicle interior temperature setting switch for setting a vehicle interior temperature, a selection switch for an air-conditioning operation mode, and the like.

The controller of this embodiment is integrally structured with a control unit for controlling various control target devices connected to the output side of the controller. The control unit for controlling the operation of each of the control target devices includes a configuration (hardware and software) adapted to control the operation of each of the control target devices.

For example, in the controller, the structure (hardware and software) for controlling the operation of the compressor 11 serves as a discharge capacity control unit, and the structure (hardware and software) for controlling the operation of each of various devices 13a, 13b, 17, 19, and 21 included in the refrigerant circuit switching portions serves as a refrigerant circuit control unit.

Next, the operation of the refrigeration cycle device 10 with the above-mentioned structure in this embodiment will be described below. As mentioned above, the refrigeration cycle device 10 can adjust the temperature of the secondary battery 55, while performing air conditioning of the vehicle interior.

The operation modes for air conditioning of the vehicle interior include an air cooling mode of cooling the vehicle interior and an air heating mode of heating the vehicle interior. The operation modes for adjustment of the temperature of the secondary battery 55 include a device heating mode of heating the secondary battery 55, and a device cooling mode of cooling the secondary battery 55. Switching between these operation modes is performed by executing a control program previously stored in a storage circuit by the controller.

The control program is executed to repeat a control routine together with actuation of a vehicle system. The control routine involves reading an operation signal from the operation panel and detection signals from a group of control sensors, determining the control state of each of various control target devices based on the detection signals and operation signal read, and outputting a control signal or control voltage to each of various control target devices so as to obtain the determined control state.

Regarding the operation mode of air conditioning of the vehicle interior, in reading the operation signal from the operation panel, the refrigeration cycle device is switched to the air cooling mode when air cooling is selected by the selection switch with an air-conditioning operation switch turned on (ON). On the other hand, the refrigeration cycle device is switched to the air heating mode when air heating is selected by the selection switch with the air-conditioning operation switch turned on (ON).

Regarding the operation mode for temperature adjustment of the secondary battery 55, in reading the detection signal from the control sensor group, the refrigeration cycle device is switched to the device heating mode of heating the secondary battery 55 when the battery temperature Tb is equal to or lower than a low-temperature side reference temperature Tkl (in this embodiment, 10° C.). On the other hand, the refrigeration cycle device is switched to the device cooling mode of cooling the secondary battery when the battery temperature Tb is equal to or higher than a high-temperature side reference temperature Tkh (in this embodiment, 30° C.).

As mentioned above, the secondary battery 55 in this embodiment needs to have its temperature managed or controlled within a range of approximately not less than 10° C. nor more than 40° C. (within the appropriate temperature range). This embodiment performs switching to the device heating mode when the battery temperature Tb is equal to or lower than the low-temperature side reference temperature Tkl, and also performs switching to the device cooling mode when the battery temperature Tb is equal to or higher than the high-temperature side reference temperature Tkh, thereby controlling the battery temperature Tb in the range of not less than 10° C. nor more than 40° C. or less.

That is, in this embodiment, a warm-up reference temperature as described in the appended claims is set to 10° C. Now, the operation of the refrigeration cycle device 10 in each operation mode will be described below.

(A) Air Cooling Operation Mode

The air cooling operation mode is an operation mode of cooling the vehicle interior without adjusting the temperature of the secondary battery 55. More specifically, this operation mode is performed with an operation switch of the operation panel turned on (ON) when air-cooling is selected by the selection switch while the battery temperature Tb is higher than the low-temperature side reference temperature Tkl and lower than the high-temperature side reference temperature Tkh.

In the air cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, brings the air-cooling expansion valve 19 into a throttle state, and closes the battery opening/closing valve 21.

Thus, in the air cooling operation mode, as indicated by solid arrows of FIG. 1, the refrigeration cycle device is switched to a refrigerant circuit that allows a refrigerant to circulate through the compressor 11, the interior condenser 12, (the first three-way valve 13a, the air-heating expansion valve 15), the exterior heat exchanger 16, (the check valve 18), the air-cooling expansion valve 19, the interior evaporator 20, the accumulator 24, and the compressor 11 in this order.

With the above refrigerant circuit structure, the controller is adapted to calculate a target air temperature TAO which is a target temperature of air to be blown into the vehicle interior, based on the values of the detection signal and operation signal read. Further, the controller determines the operating state of each of various control target devices connected to the output side of the controller, based on the calculated target air temperature TAO and the detection signal from the sensor group.

For example, the refrigerant discharge capacity of the compressor 11, that is, the control signal to be output to the electric motor of the compressor 11 is determined in the following way. First, a target evaporator outlet air temperature TEO of the interior evaporator 20 is determined based on the target air temperature TAO with reference to the control map pre-stored in the controller.

Then, a control signal to be output to the electric motor of the compressor 11 is determined based on a deviation between the target evaporator outlet air temperature TEO and the temperature of blown air from the interior evaporator 20 detected by the evaporator temperature sensor such that the temperature of the air blown from the interior evaporator 20 approaches the target evaporator outlet air temperature TEO by using a feedback control method. Note that the target evaporator outlet air temperature TEO is determined in such a range that can prevent the frost formation on the interior evaporator 20 (for example, 1° C. or more).

The control voltage to be output to the electric motor of the blower 32 is determined based on the target air temperature TAO with reference to a control map pre-stored in the storage circuit. Specifically, the control voltage to be output to the electric motor is maximized in an ultra-low temperature range (maximum air-cooling range) and ultra-high temperature range (maximum air-heating range) of the target air temperature TAO, whereby the volume of ventilation air is controlled to be close to the maximum level. As the target air temperature TAO is closer to an intermediate temperature range, the volume of ventilation air is decreased.

The control signal output to the air-cooling expansion valve 19 is determined such that a supercooling degree of the refrigerant flowing into the air-cooling expansion valve 19 approaches a target supercooling degree that is previously determined so as to substantially maximize a coefficient of performance (COP) of the cycle.

A control signal to be output to a servo motor of the air mix door 34 is determined by the feedback control method such that the ventilation air temperature TAV detected by the ventilation air temperature sensor approaches the target air temperature TAO. In an operation mode for cooling the vehicle interior, the air mix door 34 may be operated so as to close the air passage on a side of the interior condenser 12.

Thus, in the refrigeration cycle device 10 in the air cooling operation mode, the high-pressure refrigerant discharged from the compressor 11 flows into the interior condenser 12. The refrigerant flowing into the interior condenser 12 exchanges heat with part of the interior ventilation air cooled by the interior evaporator 20 to dissipate heat. In this way, the ventilation air temperature TAV approaches the target air temperature TAO.

The refrigerant flowing out of the interior condenser 12 flows into the exterior heat exchanger 16 via the first three-way valve 13a, the second three-way joint 14b, and the air-heating expansion valve 15 fully opened. The refrigerant flowing into the exterior heat exchanger 16 exchanges heat with the outside air blown from the blower fan 16a to further dissipate heat therefrom.

The refrigerant flowing out of the exterior heat exchanger 16 flows into and is decompressed by the air-cooling expansion valve 19 via the third three-way joint 14c and the check valve 18 as the air-heating opening/closing valve 17 is closed and the battery opening/closing valve 21 is closed. The refrigerant decompressed by the air-cooling expansion valve 19 flows into the interior evaporator 20, and absorbs heat from the interior ventilation air blown from the blower 32 to evaporate itself. In this way, the interior ventilation air is cooled.

The refrigerant flowing out of the interior evaporator 20 flows into the accumulator 24 via the sixth three-way joint 14f and the fourth three-way joint 14d to be separated into liquid and gas phase refrigerants. The gas-phase refrigerant separated by the accumulator 24 is sucked into the compressor 11 and compressed therein again.

As mentioned above, the refrigeration cycle device 10 in the air cooling operation mode performs switching to a refrigerant circuit, in which the refrigerant dissipating its heat at the interior condenser 12 and the exterior heat exchanger 16 is decompressed by the air-cooling expansion valve 19 to evaporate itself at the interior evaporator 20. Thus, the interior ventilation air cooled by the interior evaporator 20 is blown into the vehicle interior, thereby enabling the air-cooling of the vehicle interior.

(b) Air-Cooling Device-Cooling Operation Mode

The air-cooling device-cooling operation mode is an operation mode of performing air-cooling of the vehicle interior, while cooling the secondary battery 55 at the same time. More specifically, this operation mode is performed with the operation switch of the operation panel turned on (ON) when air-cooling is selected by the selection switch and the battery temperature Tb is equal to or higher than the high-temperature side reference temperature Tkh.

In the air-cooling device-cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, brings the air-cooling expansion valve 19 into a throttle state, opens the battery opening/closing valve 21, and brings the battery expansion valve 22 into a throttle state.

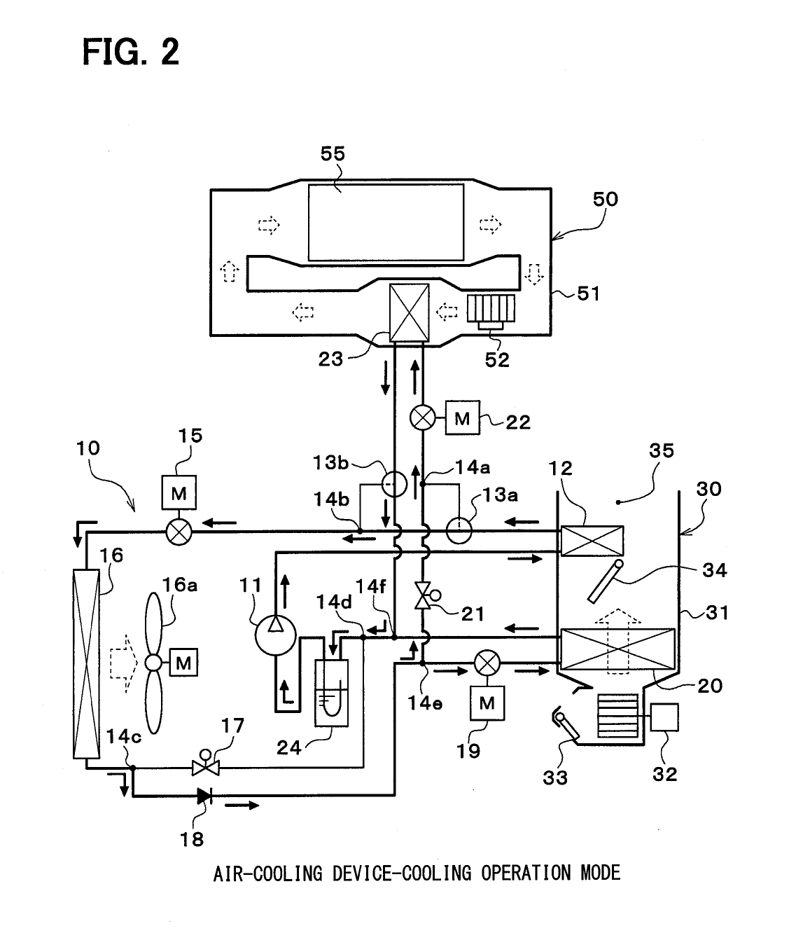

Thus, in the air-cooling device-cooling operation mode, as indicated by solid arrows of FIG. 2, the refrigeration cycle device is switched to the refrigerant circuit that allows the refrigerant to circulate through the compressor 11, the interior condenser 12, (the first three-way valve 13a, the air-heating expansion valve 15), the exterior heat exchanger 16, (the check valve 18), the air-cooling expansion valve 19, the interior evaporator 20, the accumulator 24, and the compressor 11 in this order, while allowing the refrigerant to circulate through the exterior heat exchanger 16, (the check valve 18, the battery opening/closing valve 21), the battery expansion valve 22, the battery heat exchanger 23, and the accumulator 24 in this order. That is, switching is performed to the refrigerant circuit in which the interior evaporator 20 and the battery heat exchanger 23 are connected in parallel with each other with respect to the refrigerant flow.

With such a refrigerant circuit structure, the controller determines the operating state of each of the various control target devices. For example, the control signal to be output to the battery expansion valve 22 is determined such that a throttle opening degree of the battery expansion valve 22 is a predetermined throttle opening degree. The control voltage to be output to the electric motor of the blower 52 is determined such that a blowing capacity of the blower 52 is a predetermined blowing capacity. The operating states of other control target devices are determined in the same way as in the air cooling operation mode.

Thus, in the air-cooling device-cooling operation mode, the refrigeration cycle device 10 allows the high-pressure refrigerant discharged from the compressor 11 to flow into the interior condenser 12, thereby dissipating heat into the interior ventilation air in the same way as the air cooling operation mode. In this way, the ventilation air temperature TAV approaches the target air temperature TAO. Further, the refrigerant flowing out of the interior condenser 12 flows into the exterior heat exchanger 16 to dissipate heat into the outside air.

The refrigerant flowing out of the exterior heat exchanger 16 flows into the fifth three-way joint 14e via the check valve 18 as the air-heating opening/closing valve 17 is closed, and the battery opening/closing valve 21 is open. The refrigerant is then divided into a refrigerant flowing out toward the air-cooling expansion valve 19 and another refrigerant flowing out toward the battery expansion valve 22 via the battery opening/closing valve 21.

The refrigerant flowing out of the fifth three-way joint 14e toward the air-cooling expansion valve 19 is decompressed by the air-cooling expansion valve 19 and absorbs heat from the interior ventilation air to evaporate at the interior evaporator 20 in the same way as the air cooling operation mode. In this way, the interior ventilation air is cooled. The refrigerant flowed out of the interior evaporator 20 flows into the accumulator 24, like the air cooling operation mode.

On the other hand, the refrigerant flowing out of the fifth three-way joint 14e toward the battery expansion valve 22 is decompressed by the battery expansion valve 22 to flow into the battery heat exchanger 23. The refrigerant flowing into the battery heat exchanger 23 absorbs heat from the battery ventilation air blown from the blower 52 to evaporate itself. In this way, the battery ventilation air is cooled.

The refrigerant flowing out of the battery heat exchanger 23 flows into the accumulator 24 via the second three-way valve 13b, the sixth three-way joint 14f, and the fourth three-way joint 14d. The gas-phase refrigerant separated by the accumulator 24 is drawn into the compressor 11 and compressed therein again.

As mentioned above, the refrigeration cycle device 10 in the air-cooling device-cooling operation mode performs switching to a refrigerant circuit, in which the refrigerant dissipating its heat at the interior condenser 12 and the exterior heat exchanger 16 is decompressed by the air-cooling expansion valve 19 to evaporate itself at the interior evaporator 20, and is also decompressed by the battery expansion valve 23 to evaporate itself at the battery heat exchanger 22.

Thus, the interior ventilation air cooled by the interior evaporator 20 is blown into the vehicle interior, thereby enabling the air-cooling of the vehicle interior. Further, the battery ventilation air cooled by the battery heat exchanger 23 can be blown to the secondary battery 55, thereby cooling the battery.

(c) Device Cooling Operation Mode

The device cooling operation mode is an operation mode of cooling the secondary battery 55 without performing air conditioning of the vehicle interior. More specifically, this operation mode is performed with the operation switch of the operation panel turned off (OFF) when the battery temperature Tb is equal to or higher than the high-temperature side reference temperature Tkh.

In the device cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, completely closes the air-cooling expansion valve 19, opens the battery opening/closing valve 21, and brings the battery expansion valve 22 into a throttle state.

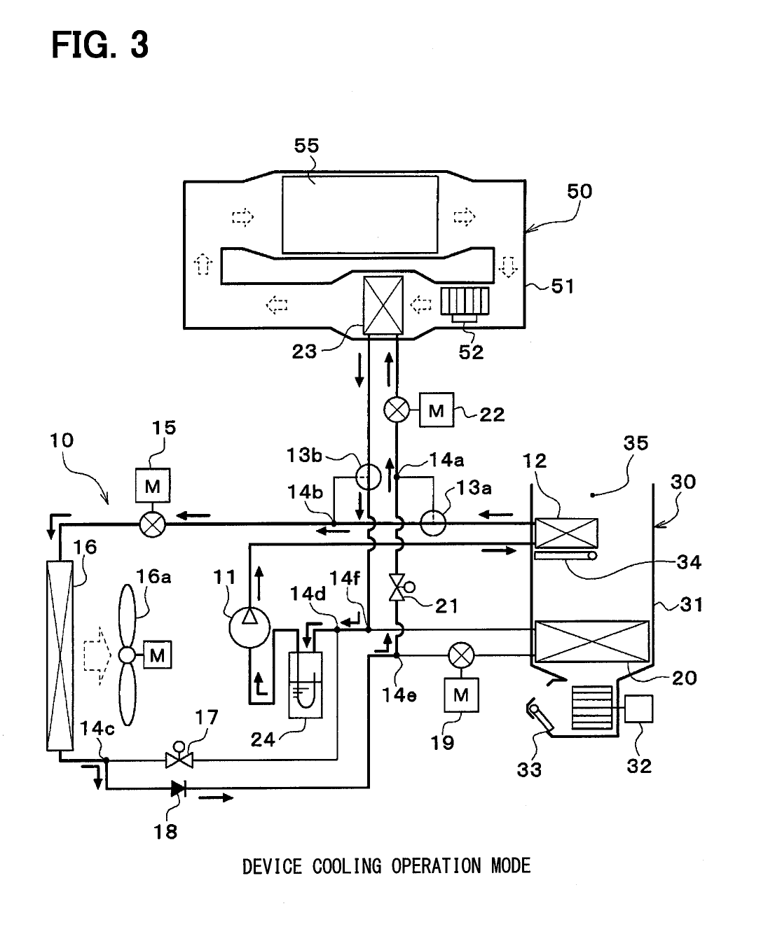

Thus, in the device cooling operation mode, as indicated by solid arrows of FIG. 3, the refrigeration cycle device is switched to a refrigerant circuit that allows a refrigerant to circulate through the compressor 11, (the interior condenser 12, the first three-way valve 13a, the air-heating expansion valve 15), the exterior heat exchanger 16, (the check valve 18), the battery opening/closing valve 21, the battery expansion valve 22, the battery heat exchanger 23, the accumulator 24, and the compressor 11 in this order.

With such a refrigerant circuit structure, the controller determines the operating state of each of the various control target devices. For example, the control signal to be output to the servo motor of the air mix door 34 is determined such that the air mix door 34 completely closes the air passage on a side of the interior condenser 12. The blower 32 of the interior air conditioning unit 30 is stopped. The operating states of other control target devices are determined in the same way as in the air-cooling device-cooling operation mode.

Thus, in the refrigeration cycle device 10 of the device cooling operation mode, the high-pressure refrigerant discharged from the compressor 11 flows into the interior condenser 12. At this time, in the device cooling operation mode, the blower 32 is stopped, and the air mix door 34 closes the air passage on the side of the interior condenser 12, so that the refrigerant flowing into the interior condenser 12 flows out of the interior condenser 12 without almost dissipating heat therefrom.

The refrigerant flowing out of the interior condenser 12 flows into the exterior heat exchanger 16 and exchanges heat with the outside air blown from the blower fan 16a to dissipate heat into the outside air in the same way as the air-cooling device-cooling operation mode. The refrigerant flowing out of the exterior heat exchanger 16 flows into and is decompressed by the battery expansion valve 22 via the check valve 18, the fifth three-way joint 14e, and the battery opening/closing valve 21, as the air-heating opening/closing valve 17 is closed, the air-cooling expansion valve 19 is completely closed, and the battery opening/closing valve 21 is opened.

The refrigerant decompressed by the battery expansion valve 22 flows into the battery heat exchanger 23 to evaporate itself. In this way, the battery ventilation air is cooled. The refrigerant flowing out of the battery heat exchanger 23 flows into the accumulator 24 via the second three-way valve 13b, the sixth three-way joint 14f, and the fourth three-way joint 14d. The gas-phase refrigerant separated by the accumulator 24 is drawn into the compressor 11 and compressed therein again.

As mentioned above, the refrigeration cycle device 10 in the device cooling operation mode performs switching to a refrigerant circuit, in which the refrigerant dissipating its heat at the exterior heat exchanger 16 is decompressed by the battery expansion valve 22 to evaporate itself at the battery heat exchanger 23. Thus, the battery ventilation air cooled by the battery heat exchanger 23 can be blown to the secondary battery 55, thereby cooling the battery.

(d) Air Heating Operation Mode

The air heating operation mode is an operation mode of heating the vehicle interior without adjusting the temperature of the secondary battery 55. More specifically, this operation mode is performed with the operation switch of the operation panel turned on (ON) when air-heating is selected by the selection switch while the battery temperature Tb is higher than the low-temperature side reference temperature Tkl and lower than the high-temperature side reference temperature Tkh.

In the air heating operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller brings the air-heating expansion valve 15 into a throttle state, opens the air-heating opening/closing valve 17, completely closes the air-cooling expansion valve 19, and closes the battery opening/closing valve 21.

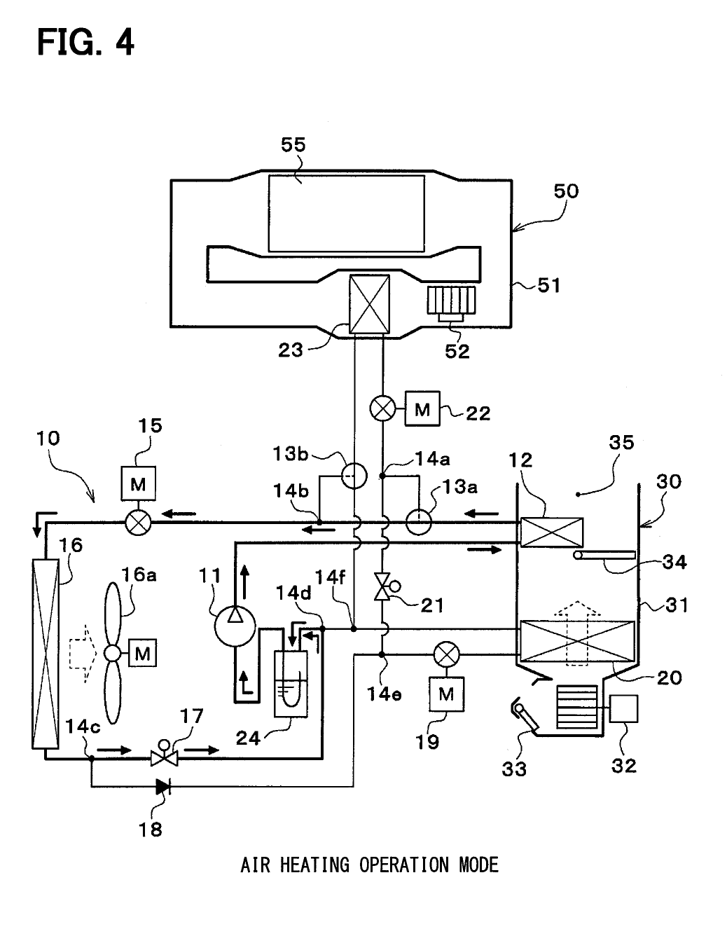

Thus, in the air heating operation mode, as indicated by solid arrows of FIG. 4, the refrigeration cycle device is switched to a refrigerant circuit that allows a refrigerant to circulate through the compressor 11, the interior condenser 12, (the first three-way valve 13a), the air-heating expansion valve 15, the exterior heat exchanger 16, (the air-heating opening/closing valve 17), the accumulator 24, and the compressor 11 in this order.

With such a refrigerant circuit structure, the controller determines the operating state of each of the various control target devices. For example, the control signal to be output to the electric motor of the compressor 11 is determined such that the ventilation air temperature TAV detected by the ventilation air temperature sensor approaches the target air temperature TAO. The target air temperature TAO determined in heating the vehicle interior is in a range of approximately 40° C. to 60° C.

The control signal to be output to the air-heating expansion valve 15 is determined such that a supercooling degree of the refrigerant flowing into the air-heating expansion valve 15 approaches a target supercooling degree that is previously determined so as to substantially maximize the COP of the cycle.

The control signal to be output to a servo motor of the air mix door 34 is determined such that the air mix door 34 fully opens the air passage on a side of the interior condenser 12. The operating states of other control target devices are determined in the same way as in the air cooling operation mode.

Thus, in the air heating operation mode, the refrigeration cycle device 10 allows the high-pressure refrigerant discharged from the compressor 11 to flow into the interior condenser 12 to exchange heat with the interior ventilation air, thereby dissipating heat from the refrigerant. In this way, the interior ventilation air is heated. The refrigerant flowing out of the interior condenser 12 flows into and is decompressed by the air-heating expansion valve 15 via the first three-way valve 13a and the second three-way joint 14b.

The refrigerant decompressed by the air-heating expansion valve 15 flows into the exterior heat exchanger 16, and absorbs heat from the outside air blown from the blower fan 16a to evaporate itself. The refrigerant flowing out of the exterior heat exchanger 16 flows into the accumulator 24 via the fourth three-way joint 14d, as the air-heating opening/closing valve 17 is open, the air-cooling expansion valve 19 is completely closed, and the battery opening/closing valve 21 is closed. The gas-phase refrigerant separated by the accumulator 24 is drawn into the compressor 11 and compressed therein again.

As mentioned above, the refrigeration cycle device 10 in the air heating operation mode performs switching to a refrigerant circuit, in which the refrigerant dissipating its heat at the interior condenser 12 is decompressed by the air-heating expansion valve 15 to evaporate itself at the exterior heat exchanger 16. Thus, the interior ventilation air heated by the interior condenser 12 is blown into the vehicle interior, thereby enabling air-heating of the vehicle interior.

That is, the air heating operation mode is an operation mode of heating the interior ventilation air, which is a fluid to be heat-exchanged. The operation in this operation mode is included in the concept of a fluid heating operation as described in the appended claims.

(e) Air-Heating Device-Heating Operation Mode

The air-heating device-heating operation mode is an operation mode of performing air-heating of the vehicle interior, while heating the secondary battery 55 at the same time. More specifically, this operation mode is performed with the operation switch of the operation panel turned on (ON) when air-heating is selected by the selection switch and the battery temperature Tb is equal to or lower than the low-temperature side reference temperature Tkl.

In the air-heating device-heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15. Further, the controller brings the air-heating expansion valve 15 into a throttle state, closes the air-heating opening/closing valve 17, completely closes the air-cooling expansion valve 19, closes the battery opening/closing valve 21, and brings the battery expansion valve 22 into a throttle state.

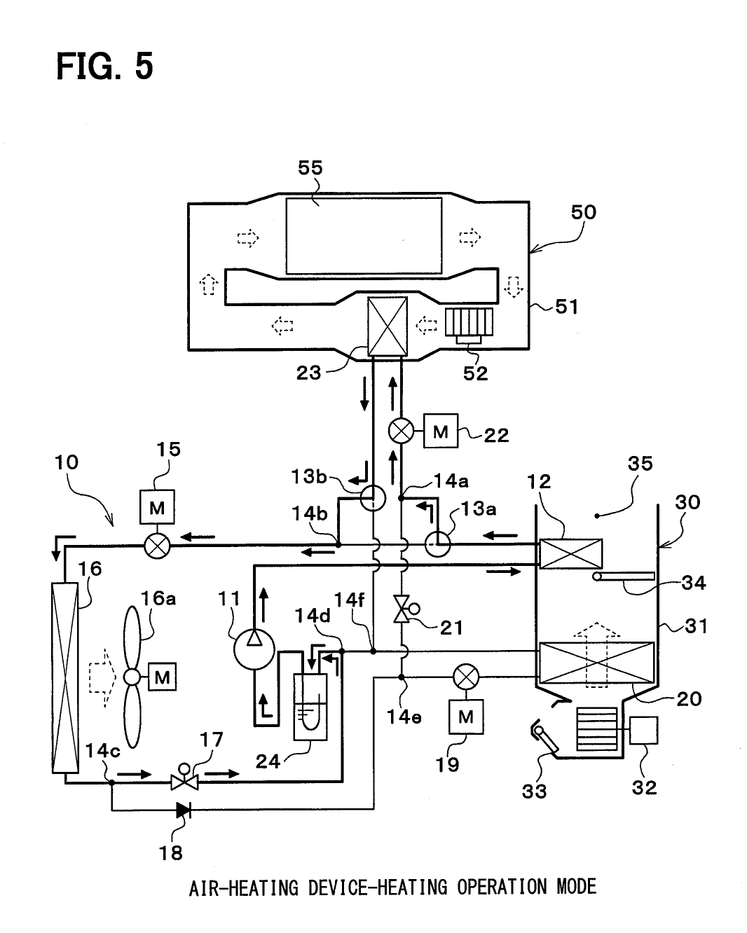

Thus, in the air-heating device-heating operation mode, as indicated by solid arrows of FIG. 5, the refrigeration cycle device is switched to a refrigerant circuit that allows a refrigerant to circulate through the compressor 11, the interior condenser 12, (the first three-way valve 13a), the battery expansion valve 22, the battery heat exchanger 23, (the second three-way valve 13b), the air-heating expansion valve 15, the exterior heat exchanger 16, (the air-heating opening/closing valve 17), the accumulator 24, and the compressor 11 in this order. That is, the refrigeration cycle device is switched to the refrigerant circuit in which the interior condenser 12 and the battery heat exchanger 23 are connected in series with respect to the refrigerant flow in this order.

With such a refrigerant circuit structure, the controller determines the operating state of each of the various control target devices. For example, the control signal to be output to the battery expansion valve 22 is determined such that the refrigerant pressure within the battery heat exchanger 23 becomes an intermediate pressure that can adjust the battery temperature Tb in an appropriate temperature range (in this embodiment, 10° C. to 40° C.).

The control voltage to be output to the electric motor of the blower 52 is determined such that a blowing capacity of the blower 52 is a predetermined blowing capacity. The operating states of other control target devices are determined in the same way as in the air heating operation mode.

Thus, in the air-heating device-heating operation mode, the refrigeration cycle device 10 allows the high-pressure refrigerant discharged from the compressor 11 to flow into the interior condenser 12, thereby dissipating heat into the interior ventilation air in the same way as the air heating operation mode. In this way, the interior ventilation air is heated. The refrigerant flowing out of the interior condenser 12 flows into the battery expansion valve 22 via the first three-way valve 13a and the first three-way joint 14a to be decompressed by the battery expansion valve 22 into the intermediate-pressure refrigerant.

The intermediate-pressure refrigerant decompressed by the battery expansion valve 22 flows into the battery heat exchanger 23 to exchange heat with the battery ventilation air, thereby dissipating heat therefrom. In this way, the battery ventilation air is heated. The refrigerant flowing out of the battery heat exchanger 23 flows into the air-heating expansion valve 15 via the second three-way valve 13b and the second three-way joint 14b, and is decompressed by the air-heating expansion valve 15. The refrigerant decompressed by the air-heating expansion valve 15 flows into the exterior heat exchanger 16 and absorbs heat from the outside air blown from the blower fan 16a to evaporate itself.

The refrigerant flowing out of the exterior heat exchanger 16 flows into the accumulator 24, like the air heating operation mode. The gas-phase refrigerant separated by the accumulator 24 is drawn into the compressor 11 and compressed therein again.

As mentioned above, the refrigeration cycle device 10 in the air-heating device-heating operation mode performs switching to a refrigerant circuit, in which the refrigerant dissipating its heat at the interior condenser 12 and the battery heat exchanger 23 is decompressed by the air-heating expansion valve 15 to evaporate itself at the exterior heat exchanger 16.

Thus, the interior ventilation air heated by the interior condenser 12 is blown into the vehicle interior, thereby enabling air-heating of the vehicle interior. Further, the battery ventilation air heated by the battery heat exchanger 23 can be blown to the secondary battery 55, thereby heating the battery.

That is, the air-heating device-heating operation mode is an operation mode of heating the interior ventilation air, while heating the secondary battery 55 using the refrigerant discharged from the compressor 11 as a hot heat source.

The operation in this operation mode is included not only in the concept of the fluid heating operation, but also in the concept of a battery heating operation, as described in the appended claims.

In the air-heating device-heating operation mode, the interior condenser 12, the battery expansion valve 22, and the battery heat exchanger 23 are connected in series with respect to the refrigerant flow in this order. By adjusting the throttle opening of the battery expansion valve 22, the heat dissipation temperature (condensation temperature) of the refrigerant at the battery heat exchanger 23 can be easily lowered, as compared to the heat dissipation temperature of refrigerant at the interior condenser 12.

(f) Device-Heating Operation Mode

The device heating operation mode is an operation mode of heating the secondary battery 55 without performing air conditioning of the vehicle interior. More specifically, this operation mode is performed with the operation switch of the operation panel turned off (OFF) when the battery temperature Tb is equal to or lower than the low-temperature side reference temperature Tkl.

In the device heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15. Further, the controller brings the air-heating expansion valve 15 into a throttle state, opens the air-heating opening/closing valve 17, completely closes the air-cooling expansion valve 19, closes the battery opening/closing valve 21, and fully opens the battery expansion valve 22.

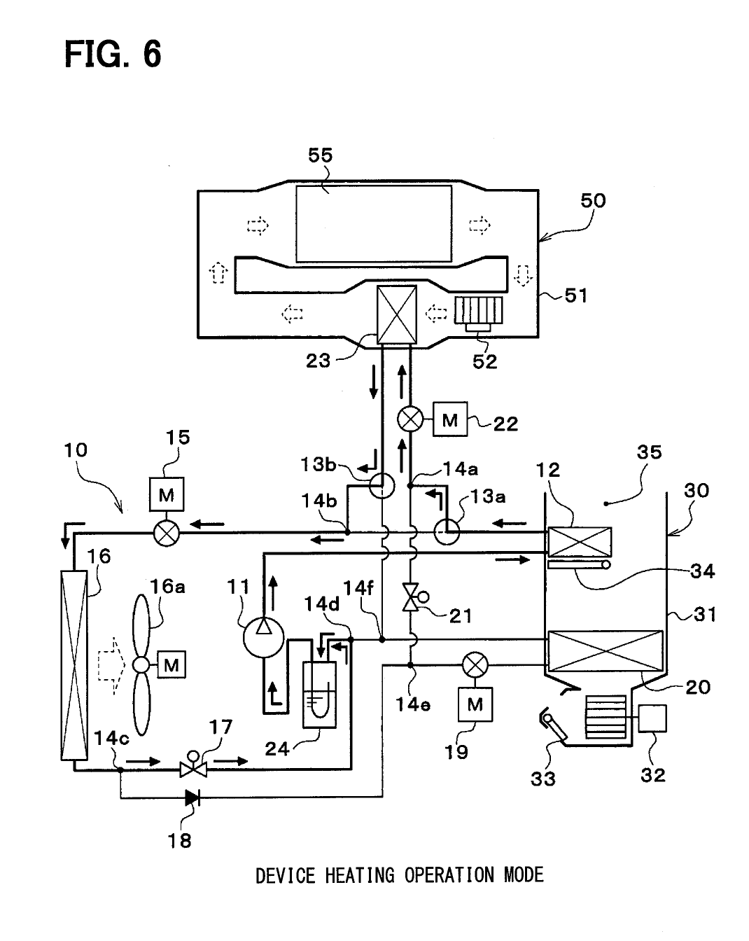

Thus, in the device heating operation mode, as indicated by solid arrows of FIG. 6, the refrigeration cycle device is switched to a refrigerant circuit that allows for circulation of the refrigerant in the same manner as that in the air-heating device-heating operation mode.

With such a refrigerant circuit structure, the controller determines the operating state of each of the various control target devices. For example, the control signal to be output to the servo motor of the air mix door 34 is determined such that the air mix door 34 completely closes the air passage on a side of the interior condenser 12. The blower 32 of the interior air conditioning unit 30 is stopped. The operating states of other control target devices are determined in the same way as in the air-heating device-heating operation mode.

Thus, in the refrigeration cycle device 10 of the device heating operation mode, the high-pressure refrigerant discharged from the compressor 11 flows into the interior condenser 12. At this time, in the device heating operation mode, the blower 32 is stopped, and the air mix door 34 closes the air passage on the side of the interior condenser 12, so that the refrigerant flowing into the interior condenser 12 flows out of the interior condenser 12 without almost dissipating heat therefrom.

The refrigerant flowing out of the interior condenser 12 flows into the battery heat exchanger 23 to exchange heat with the battery ventilation air, thereby dissipating heat therefrom. In this way, the battery ventilation air is heated. The operations following this step will be the same as those in the air-heating device-heating operation mode.

As mentioned above, the refrigeration cycle device 10 in the device heating operation mode performs switching to a refrigerant circuit, in which the refrigerant dissipating its heat at the battery heat exchanger 23 is decompressed by the air-heating expansion valve 15 to evaporate itself at the exterior heat exchanger 16. Therefore, the battery ventilation air heated by the battery heat exchanger 23 can be blown to the secondary battery 55, thereby heating the battery.

That is, the device heating operation mode is an operation mode of heating the secondary battery 55 using the refrigerant discharged from the compressor 11 as a hot heat source. The operation in this operation mode is included in the concept of the battery heating operation as described in the appended claims.

The above-mentioned respective operation modes (a) to (c) are performed to cool the vehicle interior or the secondary battery 55 when the outside air temperature is high, mainly, in summer or the like. The above-mentioned respective operation modes (d) to (f) are performed to heat the vehicle interior or the secondary battery 55 when the outside air temperature is low, mainly, in winter or the like.

On the other hand, in spring or autumn when the outside air temperature is less likely to become high or low, even though air-heating is selected by the selection switch with the operation switch of the operation panel turned on (ON), the battery temperature Tb might increase to the high-temperature side reference temperature Tkh or more in some cases. In such a case, the refrigeration cycle device 10 of this embodiment can also execute an air-heating device-cooling operation mode (g).

Even though the air-cooling is selected by the selection switch, the battery temperature Tb might decrease to the low-temperature side reference temperature Tkl or less in some cases. In such a case, the refrigeration cycle device 10 of this embodiment can also execute an air-cooling device-heating operation mode (h).

(g) Air-Heating Device-Cooling Operation Mode

In the air-heating device-cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller brings the air-heating expansion valve 15 into a throttle state, closes the air-heating opening/closing valve 17, completely closes the air-cooling expansion valve 19, opens the battery opening/closing valve 21, and brings the battery expansion valve 22 into a throttle state.

Thus, in the air-heating device-cooling operation mode, the refrigeration cycle device is switched to a refrigerant circuit that allows a refrigerant to circulate through the compressor 11, the interior condenser 12, (the first three-way valve 13a), the air-heating expansion valve 15, the exterior heat exchanger 16, (the check valve 18), the battery opening/closing valve 21, the battery expansion valve 22, the battery heat exchanger 23, the accumulator 24, and the compressor 11 in this order.

With such a refrigerant circuit structure, the controller determines the operating state of each of the various control target devices. For example, the control signal to be output to the electric motor of the compressor 11 and the control voltage to be output to the electric motor of the blower 32 are determined in the same way as that in the air heating operation mode. The control signal to be output to the servo motor of the air mix door 34 is determined such that the air mix door 34 fully opens the air passage on a side of the interior condenser 12.

The control voltage to be output to the electric motor of the blower 52 is determined such that a blowing capacity of the blower 52 is a predetermined blowing capacity. The control signal to be output to the air-heating expansion valve 15 is determined such that the temperature of refrigerant flowing into the exterior heat exchanger 16 is equal to or less than the outside air temperature Tam. The control signal to be output to the battery expansion valve 22 is determined such that a throttle opening degree of the battery expansion valve 22 is a predetermined throttle opening degree.

Thus, in the air-heating device-cooling operation mode, the refrigeration cycle device can be switched to a refrigerant circuit, in which the refrigerant dissipating its heat at the interior condenser 12 is decompressed by the air-heating expansion valve 15 to evaporate itself at the exterior heat exchanger 16, and is also decompressed by the battery expansion valve 22 to evaporate itself at the battery heat exchanger 23.

The interior ventilation air heated by the interior condenser 12 is blown into the vehicle compartment, thereby performing air-heating of the vehicle interior, and the battery ventilation air cooled by the battery heat exchanger 23 is blown to the secondary battery 55, thereby enabling cooling of the battery.

(h) Air-Cooling Device-Heating Operation Mode

In the air-cooling device-heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15. Further, the controller fully opens the air-heating expansion valve 15, closes the air-heating opening/closing valve 17, brings the air-cooling expansion valve 19 into a throttle state, and closes the battery opening/closing valve 21.

Thus, in the air-cooling device-heating operation mode, the refrigeration cycle device is switched to a refrigerant circuit that allows a refrigerant to circulate through the compressor 11, the interior condenser 12, (the first three-way valve 13a), the battery expansion valve 22, the battery heat exchanger 23, (the second three-way valve 13b), the air-heating expansion valve 15, the exterior heat exchanger 16, (the check valve 18), the air-cooling expansion valve 19, the interior evaporator 20, the accumulator 24, and the compressor 11 in this order.

With such a refrigerant circuit structure, the controller determines the operating state of each of the various control target devices. For example, the control signal to be output to the electric motor of the compressor 11 and the control voltage to be output to the electric motor of the blower 32 are determined in the same way as that in the air cooling operation mode. The control signal to be output to the servo motor of the air mix door 34 is determined such that the ventilation air temperature TAV approaches the target air temperature TAO.

The control voltage to be output to the electric motor of the blower 52 is determined such that a blowing capacity of the blower 52 is a predetermined blowing capacity. The control signal to be output to the battery expansion valve 22 is determined in the same way as in the air-heating device-heating operation mode.

Thus, in the air-cooling device-heating operation mode, the refrigeration cycle device can be switched to a refrigerant circuit, in which the refrigerant dissipating its heat at the battery heat exchanger 23 and the exterior heat exchanger 16 is decompressed by the air-cooling expansion valve 19 to evaporate itself at the interior evaporator 20.

The interior ventilation air cooled by the interior evaporator 20 is blown into the vehicle compartment, thereby performing air-cooling of the vehicle interior, and the battery ventilation air heated by the battery heat exchanger 23 is blown to the secondary battery 55, thereby enabling heating of the battery.

As mentioned above, the refrigeration cycle device 10 of this embodiment switches the refrigerant circuit, and thereby can perform air-heating and air-cooling of the vehicle interior, while adjusting the battery temperature Tb of the secondary battery 55 in the appropriate temperature range (in this embodiment, of 10° C. to 40° C.).

In an air heating operation mode (d), an air-heating device-heating operation mode (e) as described above, and the like, the exterior heat exchanger 16 functions as the evaporator. Thus, for example, when the air heating operation mode (d) or the air-heating device-heating operation mode (e) is executed under a low outside air temperature, the refrigerant evaporation temperature at the exterior heat exchanger 16 might be equal to or lower than the frost formation temperature (specifically, 0° C.), causing the formation of frost on the exterior heat exchanger 16.

Such formation of frost would close the outside air passage of the exterior heat exchanger 16 with the frost, drastically degrading the heat exchange performance of the exterior heat exchanger 16. As a result, the amount of heat absorbed by the refrigerant from the outside air at the exterior heat exchanger 16 is drastically reduced, whereby the refrigeration cycle device 10 might possibly fail to sufficiently perform air-heating of the vehicle interior or to sufficiently heat the secondary battery 55.

For this reason, the refrigeration cycle device 10 of this embodiment is adapted to perform a defrost operation to remove frost when it is formed on the exterior heat exchanger 16. More specifically, the refrigeration cycle device 10 of this embodiment includes frost formation determining portion that determines whether frost is formed on the exterior heat exchanger 16 or not. If the frost formation determining portion determines that the frost is formed on the exterior heat exchanger 16, the defrost operation will be executed as described below.

The frost formation determining portion of this embodiment is comprised of a means associated with a control step in a control program executed by the controller. Specifically, the frost formation determining portion can employ a determination unit or the like adapted to determine that frost is formed on the exterior heat exchanger 16 if the exterior device temperature Ts detected by the exterior device temperature sensor is equal to or less than a reference frost formation temperature Tks (for example, −10° C.). Now, the operation of the refrigeration cycle device 10 in the defrost operation mode will be described below.

(i) Defrost Operation Mode

In the defrost operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24. Further, the controller brings the air-heating expansion valve 15 into a throttle state, closes the air-heating opening/closing valve 17, completely closes the air-cooling expansion valve 19, opens the battery opening/closing valve 21, and brings the battery expansion valve 22 into a throttle state.

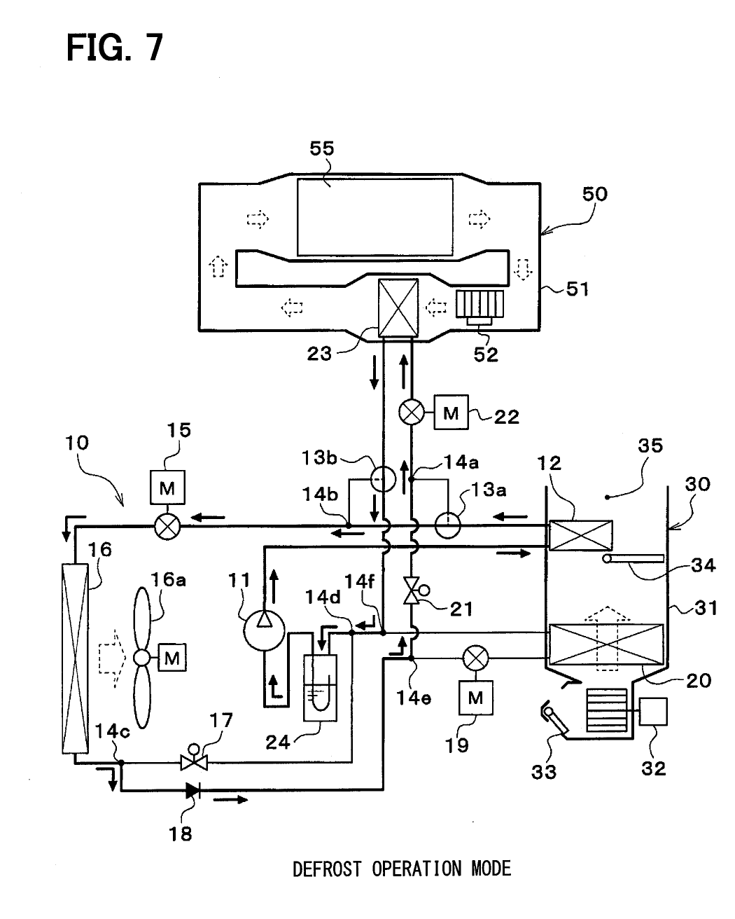

Thus, in the defrost operation mode, as indicated by solid arrows of FIG. 7, like the air-heating device-cooling operation mode, the refrigeration cycle device is switched to a refrigerant circuit that allows a refrigerant to circulate through the compressor 11, the interior condenser 12, (the first three-way valve 13a), the air-heating expansion valve 15, the exterior heat exchanger 16, (the check valve 18), the battery opening/closing valve 21, the battery expansion valve 22, the battery heat exchanger 23, (the second three-way valve 13b), the accumulator 24, and the compressor 11 in this order.

With such a refrigerant circuit structure, the controller determines the operating state of each of the various control target devices. For example, the control signal to be output to the electric motor of the compressor 11 and the control voltage to be output to the electric motor of the blower 32 are determined in the same way as that in the air heating operation mode. The control signal to be output to the servo motor of the air mix door 34 is determined such that the air mix door 34 fully opens the air passage on a side of the interior condenser 12.

The control voltage to be output to the electric motor of the blower 52 is determined in the same way as in the device cooling operation mode. The control signal to be output to the air-heating expansion valve 15 is determined such that the temperature of refrigerant flowing into the exterior heat exchanger 16 is equal to or more than 0° C., and higher than the outside air temperature Tam (specifically, approximately 15° C.). The control signal to be output to the battery expansion valve 22 is determined in the same way as in the air-cooling device-cooling operation mode.

Therefore, in the refrigeration cycle device 10 in the defrost operation mode, as indicated by dashed lines in the Mollier chart of FIG. 9, the refrigerant discharged from the compressor 11 (as indicated by a point a9 in FIG. 9) flows into the interior condenser 12 and dissipates heat in the same way as in the air heating operation mode (as indicated from the point a9 to a point b9 in FIG. 9). In this way, the interior ventilation air is heated. The refrigerant flowing out of the interior condenser 12 flows into the air-heating expansion valve 15 via the first three-way valve 13a, and is decompressed by the air-heating expansion valve 15 (as indicated from the point b9 to a point c9 in FIG. 9).

Specifically, the refrigeration cycle device 10 of this embodiment employs R134a as the refrigerant, and thus the air-heating expansion valve 15 decompresses the refrigerant to approximately 0.415 MPa (saturation temperature 15° C.).

The refrigerant flowing out of the air-heating expansion valve 15 flows into the exterior heat exchanger 16. Thus, the heat contained in the refrigerant is dissipated into the exterior heat exchanger 16 (as indicated from the point c9 to a point d9 in FIG. 9), thereby defrosting the exterior heat exchanger 16. Like the device cooling operation mode, the refrigerant flowing out of the exterior heat exchanger 16 flows into the battery expansion valve 22 via the check valve 18, the fifth three-way joint 14e, and the battery opening/closing valve 21 and is decompressed by the battery expansion valve 22 (as indicated from the point d9 to a point e9 in FIG. 9).

The refrigerant decompressed by the battery expansion valve 22 flows into the battery heat exchanger 23 to evaporate itself (as indicated from the point e9 to a point f9 in FIG. 9). In this way, the battery ventilation air is cooled. The refrigerant flowing out of the battery heat exchanger 23 flows into the accumulator 24 via the second three-way valve 13b and the like. The gas-phase refrigerant separated by the accumulator 24 is drawn into the compressor 11 and compressed therein again.

As mentioned above, the refrigeration cycle device 10 in the defrost operation mode performs switching to a refrigerant circuit, in which the refrigerant discharged from the compressor 11 dissipates its heat at the interior condenser 12 and the exterior heat exchanger 16, and the refrigerant dissipating its heat at the interior condenser 12 and the exterior heat exchanger 16 is decompressed by the battery expansion valve 22 to evaporate itself at the battery heat exchanger 23.

Thus, in the defrost operation, the high-temperature refrigerant discharged from the compressor 11 is allowed to flow into the interior condenser 12 and the exterior heat exchanger 16. In order to heat the interior ventilation air by the interior condenser 12, and to defrost the exterior heat exchanger 16, the defrost operation can utilize the amount of heat obtained by adding an amount of heat absorbed from the secondary battery 55 via the battery ventilation air in evaporating the low-pressure refrigerant at the battery heat exchanger 23 to an amount of heat corresponding to the compression workload of the compressor 11.

As mentioned above, the secondary battery 55 of this embodiment has a relatively high heat capacity, and thus can store therein heat required for heating the interior ventilation air to some degree that can sufficiently perform air-heating of the vehicle interior, and another heat required for defrosting the exterior heat exchanger 16. Thus, in the defrost operation, the heat absorbed from the secondary battery 55 can be used not only to defrost the exterior heat exchanger 16, but also to sufficiently heat the interior ventilation air at the interior condenser 12.

That is, the refrigeration cycle device 10 of this embodiment can suppress reduction in heating capacity of the interior condenser 12 for the interior ventilation air, and can also achieve the sufficient air-heating of the vehicle interior even during the defrost operation of the exterior heat exchanger 16.

In the defrost operation, the refrigeration cycle device 10 of this embodiment performs switching to a refrigerant circuit, in which the refrigerant dissipating its heat at the interior condenser 12 is decompressed by the air-heating expansion valve 15 to flow into the exterior heat exchanger 16, and further the refrigerant dissipating its heat at the exterior heat exchanger 16 is also decompressed by the battery expansion valve 22 to evaporate at the battery heat exchanger 23.

Thus, in the defrost operation, the temperature of heat dissipation from the refrigerant at the interior condenser 12 (condensation temperature) can be set higher than the temperature of heat dissipation from the refrigerant at the exterior heat exchanger 16. Thus, the interior condenser 12 can raise the temperature of interior ventilation air up to a temperature required for air-heating of the vehicle interior (specifically, about 40° C. to 60° C.). The temperature of refrigerant flowing into the exterior heat exchanger 16 can be reduced to an adequate temperature required for defrosting the exterior heat exchanger 16 (specifically, about 5° C. to 15° C.).

As a result, in the defrost operation, the heat contained in the refrigerant discharged from the compressor 11 can be effectively used to heat the interior ventilation air without unnecessarily increasing the heat dissipation temperature of refrigerant at the exterior heat exchanger 16. Further, the power consumption of the compressor 11 can be reduced.

The refrigeration cycle device 10 of this embodiment can perform the battery heating operation for heating the secondary battery 55, as described in the paragraphs of the air-heating device-heating operation mode (e) and the device heating operation mode (f). Even under a low outside air temperature, the battery heating operation can be performed to set the battery temperature Tb to a warm-up reference temperature (in this embodiment, 10° C.) or higher.

That is, the battery heating operation is performed even under the low outside air temperature, so that the heat required for sufficiently heating the vehicle interior and for defrosting the exterior heat exchanger 16 in the defrost operation can be stored in the secondary battery 55.

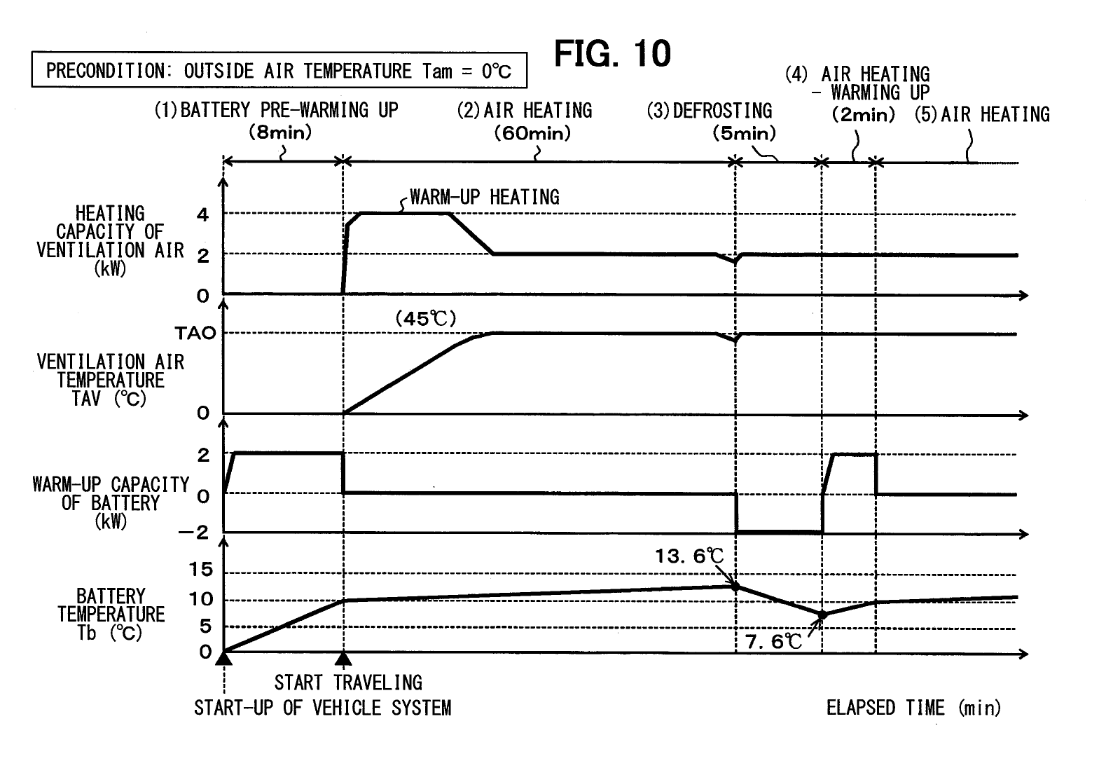

This will be specifically described using the time chart of FIG. 10. The time chart shows changes in the battery temperature Tb of the secondary battery 55 or the like after starting up a vehicle system of the electric vehicle in this embodiment at the low outside air temperature (specifically, at the outside air temperature Tam=0° C.).

First, when the electric vehicle of this embodiment stays under an environment at the low outside air temperature while the vehicle system stops, the battery temperature Tb might be lowered to the substantially same temperature as the outside air temperature Tam (in this embodiment 0° C.). As mentioned above, to cause the vehicle to run by making effective use of the capacity of the secondary battery 55, it is necessary to warm up the secondary battery 55 before the vehicle starts running so as to raise the battery temperature Tb up to 10° C. or higher.

From this aspect, in the refrigeration cycle device 10 of this embodiment, during a time period (1) for the battery pre-warming up shown in FIG. 10, that is, after start-up of the vehicle system and before starting travel of the vehicle, the secondary battery 55 is warmed up. Specifically, during the time period (1) for the battery pre-warming up shown in FIG. 10, the refrigeration cycle device 10 is operated in a device heating operation mode (f), thereby warming up the secondary battery 55.

At this time, when a warm-up capacity of the secondary battery 55 in the refrigeration cycle device 10 is set to 2 kW, the secondary battery 55 of this embodiment has its battery temperature Tb raised from 0° C. up to the warm-up reference temperature (in this embodiment, 10° C.) in approximately eight minutes.

Then, once the battery temperature Tb reaches 10° C., the vehicle starts traveling. At this time, since the outside air temperature Tam is 0° C., in this embodiment, it is assumed that the passenger selects the air-heating operation by using the selection switch on the operation panel. Thus, during a time period (2) for the air heating shown in FIG. 10, the air-heating of the vehicle interior is performed while traveling the vehicle. Specifically, during the time period (2) for the air-heating shown in FIG. 10, the refrigeration cycle device 10 is operated in the air heating operation mode (d), thereby heating the vehicle interior.

Note that since at the initial stage of air-heating, the temperature of the vehicle interior is substantially as low as the outside air temperature Tam, warm-up heating is performed which involves setting the number of revolutions of the compressor 11 in the refrigeration cycle device 10 to the maximum number of revolutions to maximize the heating capacity for the interior ventilation air (in this embodiment, about 4 kW). After the ventilation air temperature TAV of the interior ventilation air reaches the target air temperature TAO (e.g., 45° C.), the number of revolutions of the compressor 11 is controlled as described above, whereby the heating capacity for the interior ventilation air is approximately 2 kW.

During traveling of the vehicle, the secondary battery 55 generates heat by itself, resulting in an increase in temperature of the secondary battery 55. As a result of studies by the inventors, it is found out that when the electric vehicle of this embodiment travels in general urban areas, the amount of heat generated from the secondary battery 55 becomes about 360 kJ for 60 minutes, and the temperature of the secondary battery 55 increases by about 3.6° C. in 60 minutes.

If the refrigeration cycle device 10 is operated in the air heating operation mode (d), resulting in formation of frost on the exterior heat exchanger 16, the refrigeration cycle device 10 might reduce the heating capacity for the interior ventilation air. Suppose that as shown in the time chart of FIG. 10, after 60 minutes have passed since the start of traveling of the vehicle, the frost formation determining portion determines that the frost is formed on the exterior heat exchanger 16. During a time period (3) for the defrosting shown in FIG. 10, the exterior heat exchanger 16 is defrosted.

Specifically, during the time period (3) for the defrosting shown in FIG. 10, the refrigeration cycle device 10 is operated in a defrost operation mode (i), thereby defrosting the exterior heat exchanger 16. As mentioned above, in the defrost operation mode, the refrigeration cycle device 10 of this embodiment can defrost the exterior heat exchanger 16 without reducing the heating capacity for the interior ventilation air (that is, without reducing the heating capacity for the vehicle interior).

However, when the refrigeration cycle device 10 is operated in the defrost operation mode (i), the refrigerant absorbs heat from the battery ventilation air at the battery heat exchanger 23 to evaporate itself, so that the battery ventilation air is cooled to thereby cool the secondary battery 55.

According to the studies by the inventors, it is found out that in the refrigeration cycle device 10 operating in the defrost operation mode (i), when the cooling capacity of the secondary battery 55 is 2 kW (that is, the warm-up capacity is −2 kW as shown in FIG. 10), the time required for defrosting the exterior heat exchanger 16 in this embodiment is about 5 minutes, and in this time, the battery temperature Tb of the secondary battery 55 is lowered by about 6° C.

In this embodiment, during a time period (4) for the air heating-warming up, following the time period (3) for the defrosting as shown in FIG. 10, the air-heating of the vehicle interior and the heating of the secondary battery 55 are performed. Specifically, during the time period (4) for the air heating-warming up shown in FIG. 10, the refrigeration cycle device 10 is operated in the air-heating device-heating operation mode (e), thereby performing air-heating of the vehicle interior while heating the secondary battery 55.

At this time, when a warm-up capacity of the secondary battery 55 in the refrigeration cycle device 10 is set to 2 kW, the secondary battery 55 of this embodiment has its battery temperature Tb raised from 7.6° C. up to 10° C. in about two minutes. Then, after the temperature of the secondary battery 55 is raised up to 10° C., as shown in the time period (5) for the air heating shown in FIG. 10, the air-heating of the vehicle interior is performed again, in the same way as in the time period (2) for the air heating.

That is, in the refrigeration cycle device 10 of this embodiment, after completion of the defrost operation, the refrigerant circuit in the defrost operation mode (i) is switched to the refrigerant circuit in the air-heating device-heating operation mode (e) of heating the battery without switching from the refrigerant circuit in the defrost operation mode (i) directly to the air heating operation mode (d). Thus, after completion of the defrost operation, the secondary battery 55 is quickly warmed up, so that the battery temperature Tb can be set to the warm-up reference temperature.

Therefore, even under the low outside air temperature, after completion of the defrost operation, the refrigeration cycle device is switched to the refrigerant circuit in the air-heating device-heating operation mode (e), which involves heating the battery, whereby the heat required for sufficiently heating the vehicle interior and for defrosting the exterior heat exchanger 16 can be quickly stored in the secondary battery 55.

### Second Embodiment

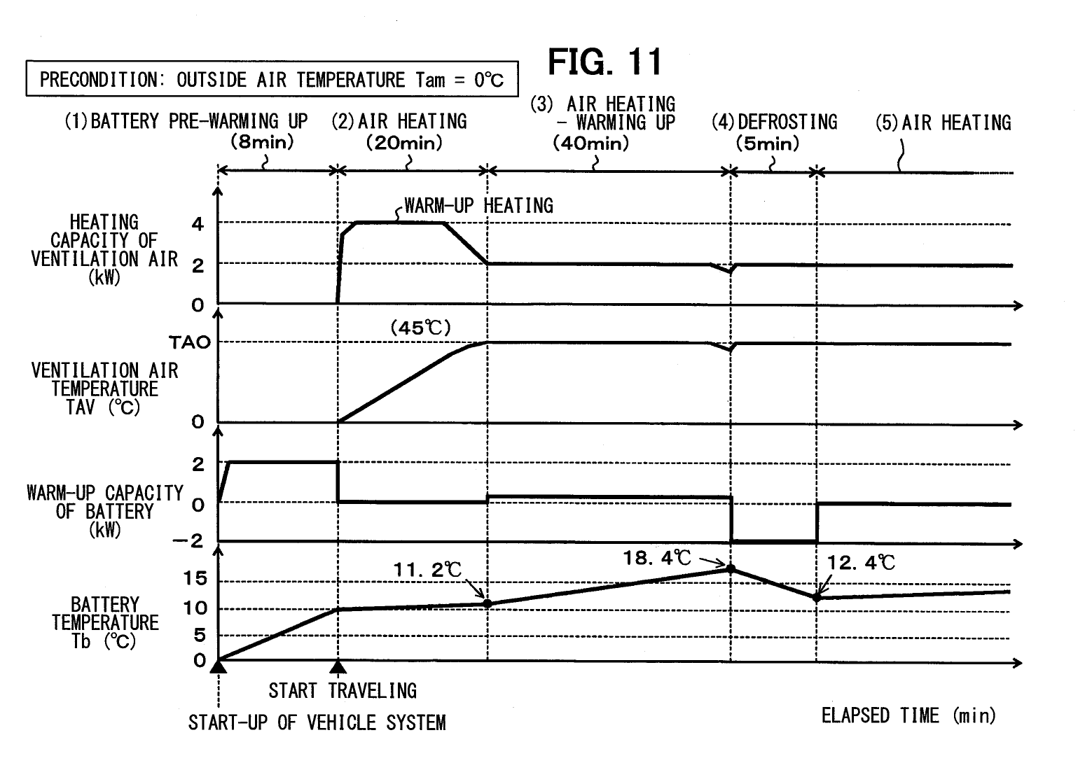

In the description of this embodiment in comparison with the first embodiment, as shown in the time chart of FIG. 11, the battery temperature Tb is raised to be higher than that in the first embodiment during traveling of the vehicle (specifically, to be about 18° C.) by way of example. Such control can be achieved by setting the warm-up reference temperature to a level higher than that in the first embodiment. The structures and operations of other components of the refrigeration cycle device 10 except for the above points are the same as those in the first embodiment.

Specifically, after the warm-up heating described in the first embodiment and during a time period (3) for air heating-warming up illustrated in FIG. 11, the refrigeration cycle device 10 of this embodiment is operated in the air-heating device-heating operation mode (e), thereby performing the air-heating of the vehicle interior and heating the secondary battery 55.

Further, during the time period (3) for the air heating-warming up in this embodiment, the warm-up capacity of the refrigeration cycle device 10 is reduced to about 0.2 kW. During this time period, the refrigeration cycle device 10 heats the secondary battery 55, and in addition, the secondary battery 55 generates heats by itself. Thus, even when the warm-up capacity of the refrigeration cycle device 10 is set to about 0.2 kW, as shown in FIG. 11, the battery temperature Tb can be raised to about 18.4° C. after 60 minutes have passed since the start of traveling of the vehicle.

Suppose that also in this embodiment, like the first embodiment, after 60 minutes have passed since the start of traveling of the vehicle, the frost formation determining portion determines that the frost is formed on the exterior heat exchanger 16. During a time period (4) for the defrost shown in FIG. 11, the exterior heat exchanger 16 is defrosted. In this way, the battery temperature Tb of the secondary battery 55 is lowered to approximately 12.4° C.

Here, like this embodiment, if the battery temperature Tb is within the appropriate temperature range after the completion of the defrost operation, it is not necessary to warm up the secondary battery 55 immediately after the completion of the defrost operation. Therefore, in this embodiment, after the completion of the defrost operation, the refrigerant circuit in the defrost operation mode (i) is directly switched to the refrigerant circuit in the air heating operation mode (d) without performing the battery heating operation.

As mentioned in this embodiment, even though the battery warm-up mode is performed to store heat in the secondary battery 55 during traveling of the vehicle before the defrost operation of the exterior heat exchanger 16, in the defrost operation, the heat absorbed from the secondary battery 55 can be used to defrost the exterior heat exchanger 16 and to sufficiently heat the interior ventilation air at the interior condenser 12, like the first embodiment.

Note that in the warm-up heating as mentioned above, the heating capacity of the refrigeration cycle device 10 for the interior ventilation air is maximized by setting the number of revolutions of the compressor 11 to the maximum number of revolutions. As a result, the refrigeration cycle device 10 in the warm-up heating does not have extra warm-up capacity for heating the battery ventilation air.

In this embodiment, after the end of the warm-up heating, the refrigeration cycle device 10 is operated in the air-heating device-heating operation mode (e). Thus, when the warm-up heating is not executed, the refrigeration cycle device 10 may be operated in the air-heating device-heating operation mode (e) at the same time as the start of traveling of the vehicle, thereby performing air-heating of the vehicle interior and heating the secondary battery 55.

### Third Embodiment

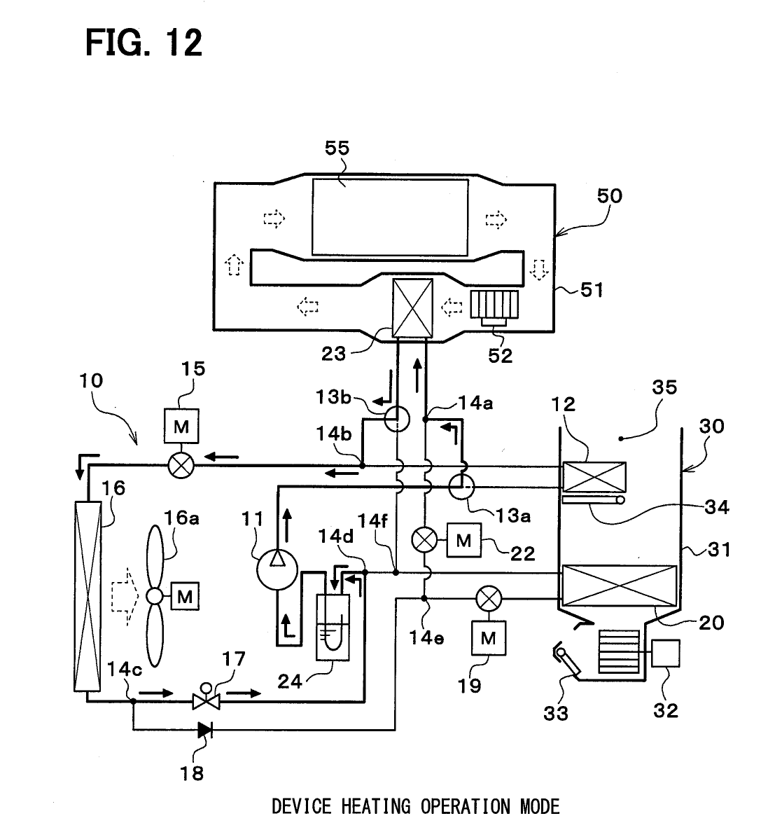

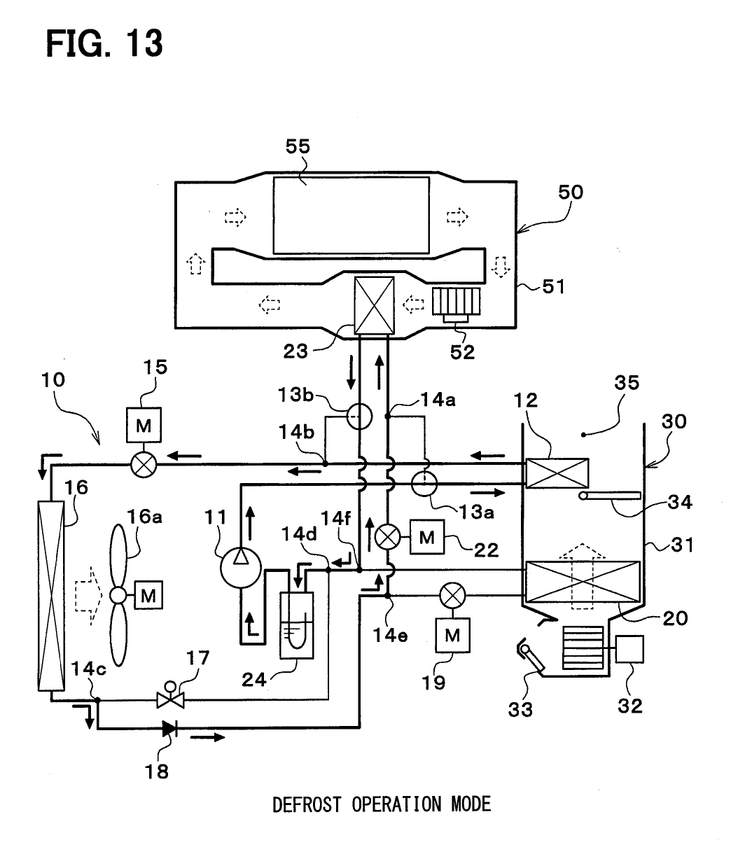

This embodiment will describe an example in which the cycle structure of the refrigeration cycle device 10 is changed as compared to the structure of the first embodiment, as illustrated in the entire configuration diagrams of FIGS. 12 and 13,

Specifically, in the refrigeration cycle device 10 of this embodiment, the first three-way valve 13a is disposed on the discharge port side of the compressor 11, the battery opening/closing valve 21 is removed, and the battery expansion valve 22 with the complete closing function is disposed in a refrigerant flow path connecting between the other refrigerant outflow port of the fifth three-way joint 14e and the other refrigerant inflow port of the first three-way joint 14a.

Therefore, the first tree-way valve 13a of this embodiment substantially switches between a refrigerant circuit connecting the discharge port side of the compressor 11 to the refrigerant inlet side of the interior condenser 12, and another refrigerant circuit connecting the discharge port side of the compressor 11 to the refrigerant inlet side of the battery heat exchanger 23. The refrigerant outlet side of the interior condenser 12 is connected to one of refrigerant inflow ports of the second three-way joint 14b.

The structures of other components in the third embodiment are the same as those in the first embodiment. The refrigeration cycle device 10 of this embodiment can perform air-conditioning of the vehicle interior as well as adjustment of the temperature of the secondary battery 55 by switching the refrigerant circuit, in the same way as in the first embodiment. Next, the respective operation modes of the refrigeration cycle device 10 in this embodiment will be described below.

(A) Air Cooling Operation Mode

In the air cooling operation mode, the controller controls the operation of the first three-way valve 13a so as to connect the discharge port side of the compressor 11 to the refrigerant inlet side of the interior condenser 12. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, brings the air-cooling expansion valve 19 into a throttle state, and completely closes the battery expansion valve 22.

In this way, like the air cooling operation mode in the first embodiment, the refrigeration cycle can be configured which allows the refrigerant dissipating its heat at the interior condenser 12 and the exterior heat exchanger 16 to be decompressed by the air-cooling expansion valve 19 and to evaporate itself at the interior evaporator 20. Thus, the interior ventilation air cooled by the interior evaporator 20 is blown to the vehicle interior, thereby enabling the air-cooling of the vehicle interior.

(b) Air-Cooling Device-Cooling Operation Mode

In the air-cooling device-cooling operation mode, the controller controls the operation of the first three-way valve 13a so as to connect the discharge port side of the compressor 11 to the refrigerant inlet side of the interior condenser 12. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, brings the air-cooling expansion valve 19 into a throttle state, and brings the battery expansion valve 22 into a throttle state.

In this way, like the air-cooling device-cooling operation mode of the first embodiment, the refrigeration cycle can be configured which allows the refrigerant dissipating its heat at the interior condenser 12 and the exterior heat exchanger 16 to be decompressed by the air-cooling expansion valve 19, then evaporating itself at the interior evaporator 20, and also to be decompressed by the battery expansion valve 22, then evaporating itself at the battery heat exchanger 23.

Thus, the interior ventilation air cooled by the interior evaporator 20 is blown to the vehicle interior, thereby enabling the air-cooling of the vehicle interior. Further, the battery ventilation air cooled by the battery heat exchanger 23 can be blown to the secondary battery 55, thereby cooling the battery.

(c) Device Cooling Operation Mode

In the device cooling operation mode, the controller controls the operation of the first three-way valve 13a so as to connect the discharge port side of the compressor 11 to the refrigerant inlet side of the interior condenser 12. The controller also controls the operation of the second three-way valve 13b so as to connect the refrigerant outlet side of the battery heat exchanger 23 to the inlet side of the accumulator 24. Further, the controller fully opens the air-heating expansion valve 15, closes the air-heating opening/closing valve 17, completely closes the air-cooling expansion valve 19, and brings the battery expansion valve 22 into a throttle state.

In this way, like the device cooling operation mode in the first embodiment, the refrigeration cycle can be configured which allows the refrigerant dissipating its heat at the exterior heat exchanger 16 to be decompressed by the battery expansion valve 22 and to evaporate itself at the battery heat exchanger 23. Thus, the battery ventilation air cooled by the battery heat exchanger 23 can be blown to the secondary battery 55, thereby cooling the battery.

(d) Air Heating Operation Mode

In the air heating operation mode, the controller controls the operation of the first three-way valve 13a so as to connect the discharge port side of the compressor 11 to the refrigerant inlet side of the interior condenser 12. The controller also controls the operation of the second three-way valve 13b so as to connect the refrigerant outlet side of the battery heat exchanger 23 to the inlet side of the accumulator 24. Further, the controller brings the air-heating expansion valve 15 into a throttle state, opens the air-heating opening/closing valve 17, completely closes the air-cooling expansion valve 19, and completely closes the battery expansion valve 22.

In this way, like the air heating operation mode in the first embodiment, the refrigeration cycle can be configured which allows the refrigerant dissipating its heat at the interior condenser 12 to be decompressed by the air-heating expansion valve 15 and to evaporate itself at the exterior heat exchanger 16. Thus, the interior ventilation air heated by the interior condenser 12 is blown into the vehicle interior, thereby enabling air-heating of the vehicle interior.

(f) Device Heating Operation Mode

In the device heating operation mode, the controller controls the operation of the first three-way valve 13a so as to connect the discharge port side of the compressor 11 to the refrigerant inlet side of the battery heat exchanger 23. The controller also controls the operation of the second three-way valve 13b so as to connect the refrigerant outlet side of the battery heat exchanger 23 to the inlet side of the air-heating expansion valve 15. Further, the controller brings the air-heating expansion valve 15 into a throttle state, opens the air-heating opening/closing valve 17, completely closes the air-cooling expansion valve 19, and completely closes the battery expansion valve 22.

Thus, in the device heating operation mode, as indicated by solid arrows of FIG. 12, the refrigeration cycle device is switched to a refrigerant circuit that allows a refrigerant to circulate through the compressor 11, (the first three-way valve 13a), the battery heat exchanger 23, (the second three-way valve 13b), the air-heating expansion valve 15, the exterior heat exchanger 16, (the air-heating opening/closing valve 17), the accumulator 24, and the compressor 11 in this order. In the device heating operation mode, the refrigeration cycle device is switched to the refrigerant circuit for circulation of the refrigerant in the same way as in the air-heating device-heating operation mode.

With such a refrigerant circuit structure, the controller determines the operating state of each of the various control target devices. For example, the control signal to be output to the electric motor of the compressor 11 is determined such that the refrigerant pressure in the battery heat exchanger 23 sets the battery temperature Tb within an appropriate temperature range (in this embodiment, 10° C. to 40° C.). The operating states of other control target devices are determined in the same way as in the device heating operation mode of the first embodiment.

In this way, like the device heating operation mode in the first embodiment, the refrigeration cycle device can be configured which allows the refrigerant dissipating its heat at the battery heat exchanger 23 to be decompressed by the air-heating expansion valve 15 and to evaporate itself at the exterior heat exchanger 16. Therefore, the battery ventilation air heated by the battery heat exchanger 23 can be blown to the secondary battery 55, thereby heating the battery. That is, the operation in this operation mode corresponds to the battery heating operation as described in the appended claims.

(i) Defrost Operation Mode

In the defrost operation mode, the controller controls the operation of the first three-way valve 13a so as to connect the discharge port side of the compressor 11 to the refrigerant inlet side of the interior condenser 12. The controller also controls the operation of the second three-way valve 13b so as to connect the refrigerant outlet side of the battery heat exchanger 23 to the inlet side of the accumulator 24. Further, the controller brings the air-heating expansion valve 15 into a throttle state, closes the air-heating opening/closing valve 17, completely closes the air-cooling expansion valve 19, and brings the battery expansion valve 22 into a throttle state.

Thus, in the defrost operation mode, as indicated by solid arrows of FIG. 13, the refrigeration cycle device is switched to a refrigerant circuit that allows the refrigerant to circulate through the compressor 11, (the first three-way valve 13a), the interior condenser 12, the air-heating expansion valve 15, the exterior heat exchanger 16, (the check valve 18), the battery expansion valve 22, the battery heat exchanger 23, (the second three-way valve 13b), the accumulator 24, and the compressor 11 in this order.

In this way, like the defrost operation mode in the first embodiment, the refrigeration cycle can be configured which allows the refrigerant dissipating its heat at the interior condenser 12 and the exterior heat exchanger 16 to be decompressed by the battery expansion valve 22 and to evaporate itself at the battery heat exchanger 23. Thus, like the defrost operation in the first embodiment, the exterior heat exchanger 16 can be defrosted, and also the interior ventilation air can be sufficiently heated at the interior condenser 12.

Further, like the first embodiment, the refrigeration cycle device 10 of this embodiment can be operated in an air-heating device-cooling operation mode (g) and in an air-cooling device-heating operation mode (h) when the outside air temperature is less likely to be relatively high or low, for example, in spring or autumn.

In this aspect, in the refrigeration cycle device 10 of this embodiment, the first three-way valve 13a is disposed on the discharge port side of the compressor 11, which cannot cause the refrigerant discharged from the compressor 11 to simultaneously flow into both the interior condenser 12 and the battery heat exchanger 23. That is, the refrigeration cycle device cannot be operated in the air-heating device-heating operation mode (e), which involves air-heating of the vehicle interior and heating of the secondary battery 55 at the same time.

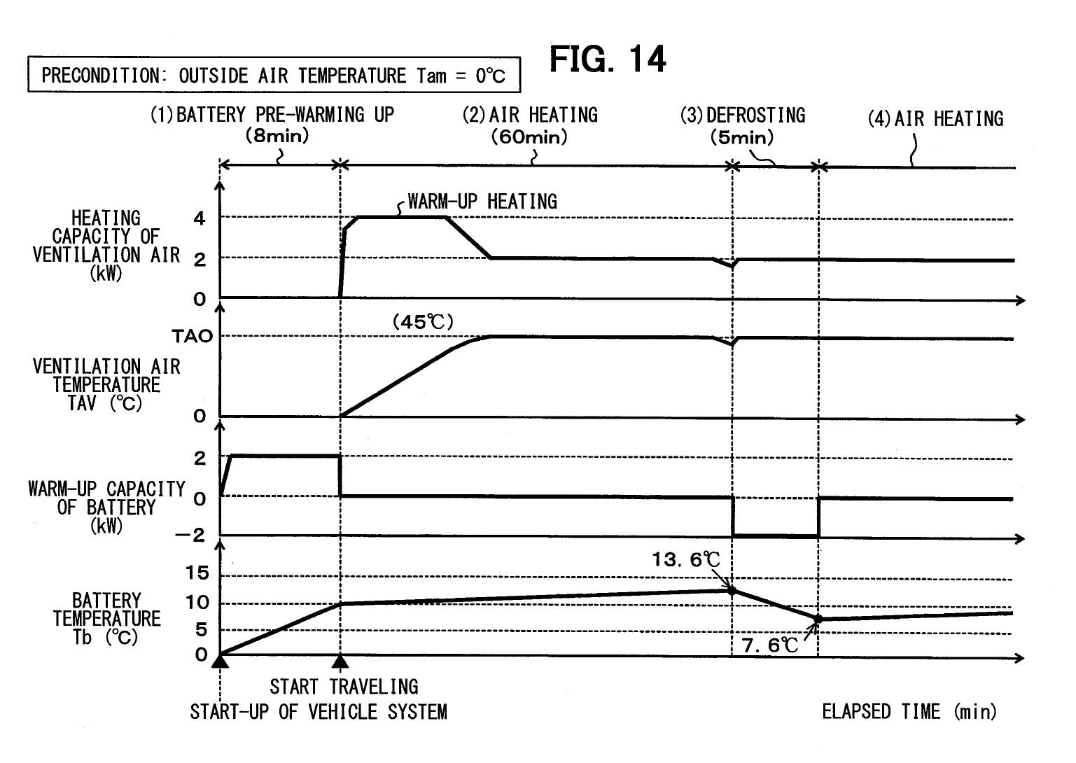

Thus, as illustrated in the time chart of FIG. 14, the refrigeration cycle device 10 of this embodiment switches the refrigerant circuit in the defrost operation mode (i), after completion of the defrost operation executed during the time period (3) for defrosting, directly to the refrigerant circuit in the air heating operation mode (d). Further, in the air heating operations (2) and (4) shown in FIG. 14, like the first embodiment, the secondary battery 55 generates heat by itself, resulting in an increase of the temperature of the secondary battery 55.

Like this embodiment, in the defrost operation, even after switching the refrigerant circuit of the refrigeration cycle device 10, the heat generated from the secondary battery 55 itself and stored in the secondary battery 55 can be used not only to defrost the exterior heat exchanger 16, but also to sufficiently heat the interior ventilation air at the interior condenser 12.

### Fourth Embodiment

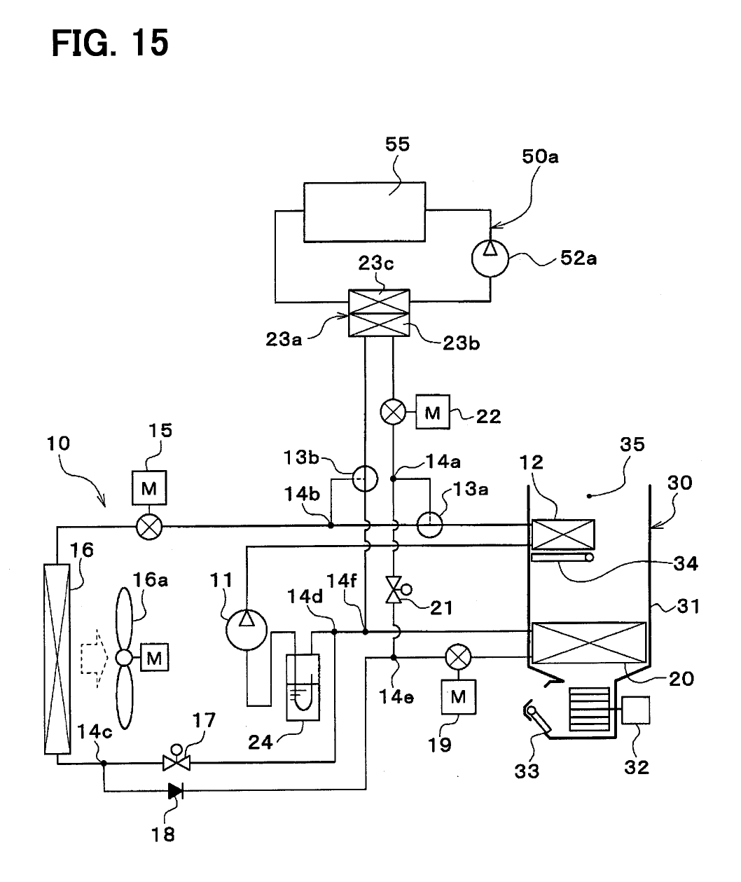

In the first embodiment, the battery ventilation air (gas) is heated or cooled to adjust the temperature of the secondary battery 55 by way of example. On the other hand, as shown in the entire configuration diagram of FIG. 15, this embodiment heats or cools the heat medium (liquid) circulating through a heat medium circuit 50a, thereby adjusting the temperature of the secondary battery 55, which will be described below by way of example.

Specifically, the heat medium circuit 50a is a circuit for circulation of the heat medium (specifically, an ethylene glycol aqueous solution) that adjusts the temperature of the secondary battery 55. More specifically, the heat medium circuit 50a is comprised of a water pump 52a for pressure-feeding the heat medium, a water passage 23c of a water-refrigerant heat exchanger 23a that exchanges heat between the heat medium and the refrigerant, and a heat medium passage formed inside or outside the secondary battery 55, which are circularly connected by pipes in the sequence.

The water pump 52a is an electric water pump having its operation (heat medium pressure-feeding capacity) controlled by a control signal output from the controller. More specifically, the water pump 52a also has its operation controlled in the respective operation modes described in the first embodiment, in the same way as the blower 52.

The water-refrigerant heat exchanger 23a is a battery heat exchanger that exchanges heat between the refrigerant circulating through the refrigerant passage 23b and the heat medium circulating through the water passage 23c. The water-refrigerant heat exchanger 23a may employ a specific structure in which a pipe forming the water passage 23c is wound around the outer periphery of a refrigerant pipe forming the refrigerant passage 23b to thereby exchange heat between the heat medium and the refrigerant.

Alternatively, another heat exchanger structure may be employed which uses a meandering tube or a plurality of tubes for permitting the flow of refrigerant as the refrigerant passage 23b, thereby forming the water passage 23c in between the adjacent tube tubes. Further, the heat exchanger is provided with corrugated fins or plate fins for promoting the heat exchange between the refrigerant and coolant.

The input side of the controller in this embodiment is connected to a heat medium inlet side temperature sensor that detects an inlet-side temperature Tin of heat medium flowing into the heat medium passage of the secondary battery 55, and also to a heat medium outlet side temperature sensor that detects an outlet-side temperature Tout of heat medium flowing out of the heat medium passage of the secondary battery 55.

In cooling or heating the secondary battery, the water pressure feeding capacity of the water pump 52a is controlled such that a difference between the inlet-side temperature Tin and the outlet-side temperature Tout is substantially equal to a predetermined temperature difference (for example, 5° C.). The structures and operations of other components in the fourth embodiment are the same as those in the first embodiment.

When the refrigeration cycle device 10 of this embodiment is operated by switching to the refrigerant circuit in the air-heating device-heating operation mode (e), the refrigerant circuit in the device heating operation mode (f), or the like, the refrigerant discharged from the compressor 11 can flow into the refrigerant passage 23b of the water-refrigerant heat exchanger 23a, thereby heating the heat medium circulating through the water passage 23c. In this way, the secondary battery 55 can be heated.

When the refrigeration cycle device 10 of this embodiment is operated by switching to the refrigerant circuit in the air-cooling device-cooling operation mode (b), the refrigerant circuit in the device cooling operation mode (c), or the like, the refrigerant decompressed by the battery expansion valve 22 can flow into the refrigerant passage 23b of the water-refrigerant heat exchanger 23a, thereby cooling the heat medium circulating through the water passage 23c. As a result, the secondary battery 55 can be cooled.

As mentioned in this embodiment, even in use of the heat medium circuit 50a, in the defrost operation, the heat absorbed from the secondary battery 55 via the heat medium can be used to defrost the exterior heat exchanger 16 and to sufficiently heat the interior ventilation air at the interior condenser 12, like the first embodiment.

### Fifth Embodiment

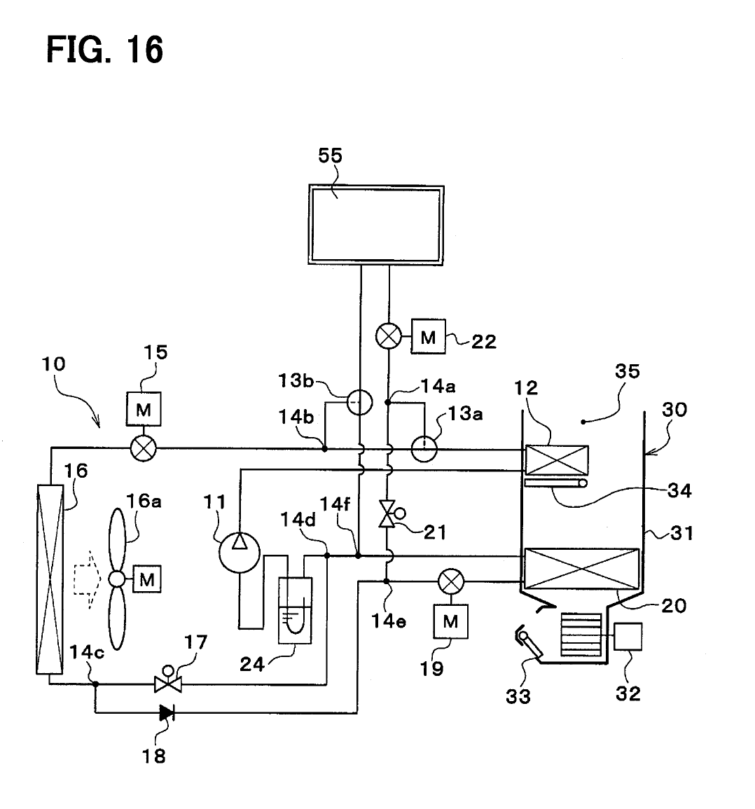

Referring to the entire configuration diagram of FIG. 16, this embodiment differs from the first embodiment in that the secondary battery 55 is directly cooled or heated by the refrigerant flowing out of the battery expansion valve 22. In more detail, the refrigerant flowing out of the battery expansion valve 22 flows out toward the second three-way valve 13b through the refrigerant passage formed inside or at the outer periphery of the secondary battery 55.

The structures and operations of other components in the fifth embodiment are the same as those in the first embodiment. In operating the refrigeration cycle device 10 of this embodiment to switch to the refrigerant circuit in the air-heating device-heating operation mode (e), in the device heating operation mode (f), or the like, the secondary battery 55 can be heated directly by the refrigerant discharged from the compressor 11.

When the refrigeration cycle device 10 is operated by switching to the refrigerant circuit in an air-cooling device-cooling operation mode (b), in a device cooling operation mode (c), or the like, the secondary battery 55 can be cooled directly by the refrigerant decompressed by the battery expansion valve 22.

Even such a structure as described in this embodiment that directly cools or heats the secondary battery 55 with the refrigerant flowing out of the battery expansion valve 22 can utilize the heat absorbed from the secondary battery 55 to defrost the exterior heat exchanger 16 in the defrost operation, while sufficiently heating the interior ventilation air at the interior condenser 12 in the same manner as in the first embodiment.

### Sixth Embodiment

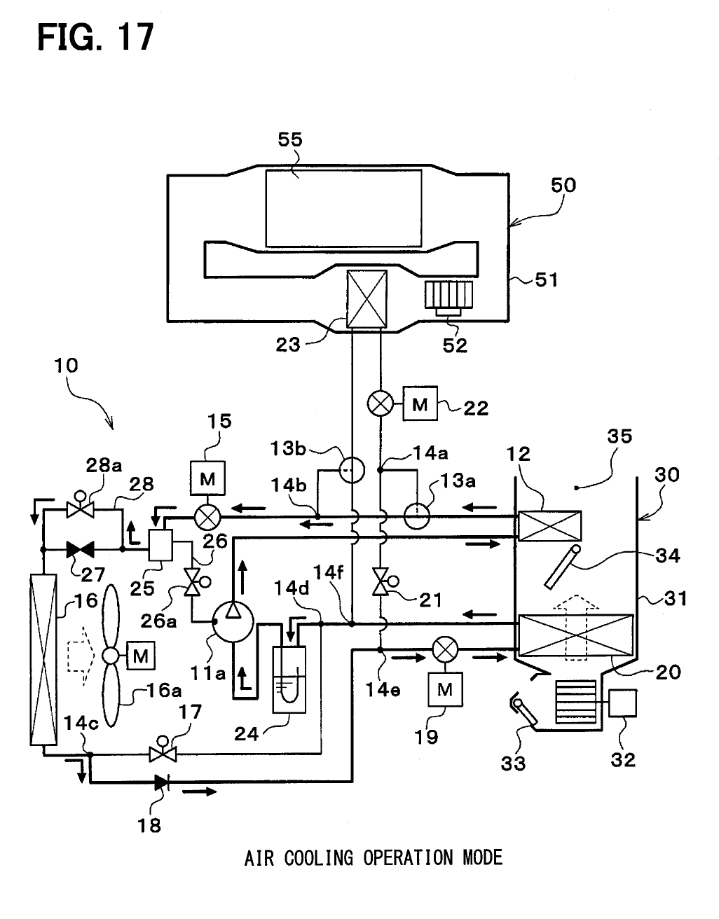

This embodiment will describe an example in which the cycle structure of the refrigeration cycle device 10a is changed with respect to the structure of the first embodiment, as illustrated in the entire configuration diagrams of FIGS. 17 to 23.

Specifically, in the refrigeration cycle device 10a of this embodiment, the compressor 11a employs the two-stage boost electric compressor that accommodates in a housing forming an outer envelope, two compression mechanisms including a low-stage side compression mechanism and a high-stage side compression mechanism, and an electric motor rotatably driving both the compression mechanisms. Note that the electric motor of the compressor 11a in this embodiment has its operation (the number of revolutions) controlled by a control signal output from the controller.

The housing of the compressor 11a is provided with a suction port that draws the low-pressure refrigerant from the outside of the housing to the low-stage side compression mechanism, and an intermediate-pressure suction port that allows the intermediate-pressure refrigerant generated in the cycle to flow from the outside of the housing thereinto, to be then merged with the refrigerant being compressed from the low pressure state to the high pressure state. Further, the housing of the compressor 11a is also provided with a discharge port that discharges the high-pressure refrigerant discharged from the high-stage side compression mechanism to the outside of the housing.

Although this embodiment employs the compressor 11a accommodating the two compression mechanisms in one housing, the form of the compressor is not limited thereto. That is, as long as the intermediate-pressure refrigerant can flow from the intermediate pressure suction port to be merged with the refrigerant being compressed from the low pressure to the high pressure, the compressor may be any electric compressor that accommodates within the housing, one fixed capacity compression mechanism, and an electric motor designed to rotatably drive the compression mechanism.

Alternatively, one two-stage booster compressor may be comprised of two compressors of a low-stage side compressor and a high-stage side compressor, which are connected in series. A suction port of the low-stage side compressor placed on a low-stage side is defined as the suction port of the entire compressor. A discharge port of the high-stage side compressor placed on a high-stage side is defined as the discharge port of the entire compressor. An intermediate pressure suction port is provided at a connection portion for connecting a discharge port of the low-stage side compressor with a suction port of the high-stage side compressor.

In this embodiment, the outlet side of the air-heating expansion valve 15 is connected to the refrigerant inflow port of the gas-liquid separator 25, which serves as the gas-liquid separator that separates the refrigerant flowing out of the air-heating expansion valve 15 into gas and liquid phase refrigerants. The gas-liquid separator 25 suitable for use can be a centrifugal separator that separates the refrigerant into the gas and liquid phase refrigerants by the action of a centrifugal force.

As shown in FIG. 17, the gas-phase refrigerant outflow port of the gas-liquid separator 25 is connected to the intermediate-pressure suction port of the compressor 11a via the gas-phase refrigerant passage 26. A gas-phase refrigerant passage opening/closing valve 26a is disposed in the gas-phase refrigerant passage 26. The gas-phase refrigerant passage opening/closing valve 26a is an electromagnetic valve having the same structure as the air-heating opening/closing valve 17 and the like, and serves as an opening/closing portion that opens and closes the gas-phase refrigerant passage 26.

Therefore, when the gas-phase refrigerant passage opening/closing valve 26a is open, the refrigeration cycle device can perform switching to the refrigerant circuit that allows the refrigerant flowing out of the gas-phase refrigerant outflow port of the gas-liquid separator 25 to be drawn from the intermediate-pressure suction port of the compressor 11a via the gas-phase refrigerant passage 26. When the gas-phase refrigerant passage opening/closing valve 26a is closed, the refrigeration cycle device can perform switching to the refrigerant circuit that prevents the refrigerant from flowing out of the gas-phase refrigerant outflow port of the gas-liquid separator 25. That is, the gas-phase refrigerant passage opening/closing valve 26a serves as the refrigerant circuit switching portion.

Note that the gas-phase refrigerant passage opening/closing valve 26a also functions as a check valve that allows for the flow of only the refrigerant from the gas-phase refrigerant outlet of the gas-liquid separator 25 to the intermediate-pressure suction port side of the compressor 11a when the gas-phase refrigerant passage 26 is open. Thus, when the gas-phase refrigerant passage opening/closing valve 26a opens the gas-phase refrigerant passage 26, the refrigerant is prevented from flowing backward from the side of the compressor 11a to the gas-liquid separator 25.

On the other hand, the liquid-phase refrigerant outflow port of the gas-liquid separator 25 is connected to the inlet side of an intermediate fixed throttle 27 that serves as a decompression device for decompressing the liquid-phase refrigerant separated by the gas-liquid separator 25. Examples of the intermediate fixed throttle 27 suitable for use can include a nozzle, an orifice, a capillary tube, etc., each having a fixed throttle opening. The outlet side of the intermediate fixed throttle 27 is connected to the refrigerant inlet side of the exterior heat exchanger 16.

The liquid-phase refrigerant outflow port of the gas-liquid separator 25 is connected to a fixed-throttle bypass passage 28 that guides the liquid-phase refrigerant separated by the gas-liquid separator 25 to the refrigerant inlet side of the exterior heat exchanger 16 while bypassing the intermediate fixed throttle 27. The fixed-throttle bypass passage 28 is provided with a bypass passage opening/closing valve 28a that opens and closes the fixed-throttle bypass passage 28. Note that the bypass passage opening/closing valves 28a has the basic same structure as that of the air-heating opening/closing valve 17 or the like.

A loss in pressure caused when the refrigerant passes through the bypass passage opening/closing valve 28a is much smaller than that caused when the refrigerant passes through the intermediate fixed throttle 27. Thus, when the controller opens the bypass passage opening/closing valve 28a, the liquid-phase refrigerant flowing out of the gas-liquid separator 25 flows into the exterior heat exchanger 16 via the fixed-throttle bypass passage 28. On the other hand, when the controller closes the bypass passage opening/closing valve 28a, the liquid-phase refrigerant flowing out of the gas-liquid separator 25 is decompressed by the intermediate fixed throttle 27, and then flows into the exterior heat exchanger 16.

The structures of other components in the sixth embodiment are the same as those in the first embodiment. The refrigeration cycle device 10a of this embodiment can perform air-conditioning of the vehicle interior as well as adjustment of the temperature of the secondary battery 55 by switching the refrigerant circuit, like the first embodiment. Next, the respective operation modes of the refrigeration cycle device 10a in this embodiment will be described below. Switching to other operating modes is performed in the same way as that in the first embodiment.

(A) Air Cooling Operation Mode

In the air cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24.

Further, the controller fully opens the air-heating expansion valve 15, closes the air-heating opening/closing valve 17, brings the air-cooling expansion valve 19 into a throttle state, completely closes the battery expansion valve 22, closes the gas-phase refrigerant passage opening/closing valve 26a, and opens the bypass passage opening/closing valve 28a.

Thus, in the air cooling operation mode of this embodiment, as indicated by solid arrows of FIG. 17, the refrigeration cycle can be configured which allows for circulation of the refrigerant in the substantially same way as in the air cooling operation mode of the first embodiment. Like the air cooling operation mode of the first embodiment, the interior ventilation air cooled by the interior evaporator 20 is blown into the vehicle interior, thereby enabling the air cooling of the vehicle interior.

Note that since in the air cooling mode, the gas-phase refrigerant passage opening/closing valve 26a is closed, the compressor 11a serves as a single-stage booster compressor. The liquid-phase refrigerant separated by the gas-liquid separator 25 flows out of the liquid-phase refrigerant outflow port taking priority over the separated gas-phase refrigerant. The same goes for other operation modes of closing the gas-phase refrigerant passage opening/closing valve 26a (for example, the air-cooling device-cooling operation mode (b), the device cooling operation mode (c), etc.)

(b) Air-Cooling Device-Cooling Operation Mode

In the air-cooling device-cooling operation mode, the controller controls the operation of the first three-way valve 13a so as to connect the refrigerant outlet side of the interior condenser 12 to one inlet side of the air-heating expansion valve 15. The controller also controls the operation of the second three-way valve 13b so as to connect the refrigerant outlet side of the battery heat exchanger 23 to the inlet side of the accumulator 24.

Further, the controller fully opens the air-heating expansion valve 15, closes the air-heating opening/closing valve 17, brings the air-cooling expansion valve 19 into a throttle state, opens the battery opening/closing valve 21, brings the battery expansion valve 22 into a throttle state, closes the gas-phase refrigerant passage opening/closing valve 26a, and opens the bypass passage opening/closing valve 28a.

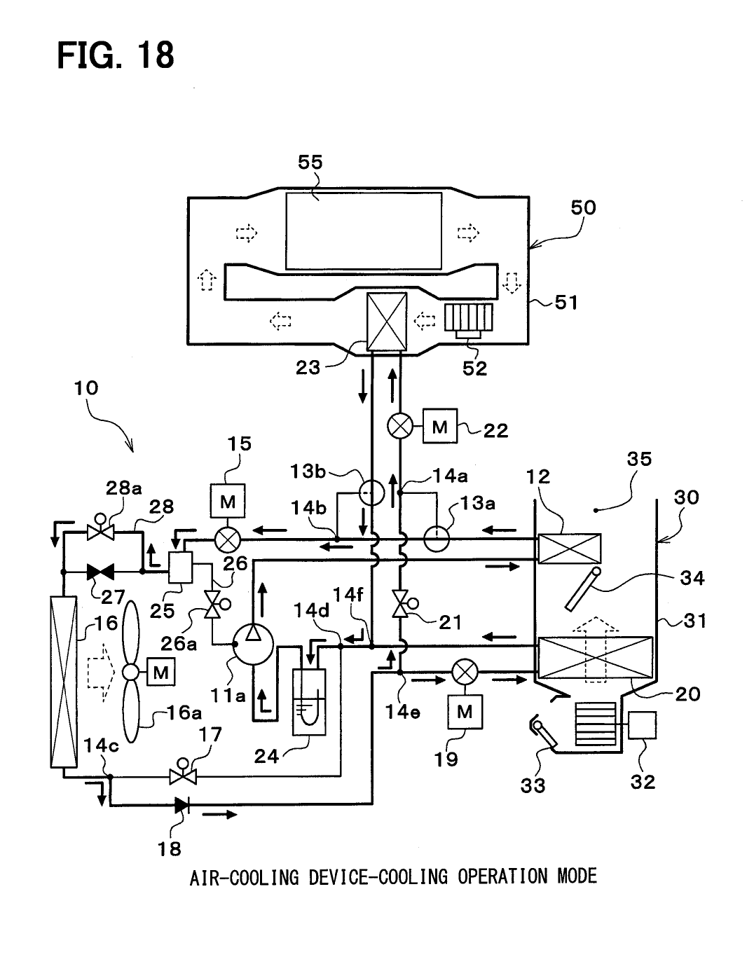

Thus, in the air-cooling device-cooling operation mode of this embodiment, as indicated by solid arrows of FIG. 18, the refrigeration cycle can be configured which allows for circulation of the refrigerant in the substantially same way as in the air-cooling device-cooling operation mode of the first embodiment. Like the air-cooling device-cooling operation mode of the first embodiment, the interior ventilation air cooled by the interior evaporator 20 is blown into the vehicle interior, thereby enabling air-cooling of the vehicle interior. Further, the battery ventilation air cooled by the battery heat exchanger 23 can be blown to the secondary battery 55, thereby cooling the battery.

(c) Device Cooling Operation Mode

In the device cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24.

Further, the controller fully opens the air-heating expansion valve 15, closes the air-heating opening/closing valve 17, completely closes the air-cooling expansion valve 19, opens the battery opening/closing valve 21, brings the battery expansion valve 22 into a throttle state, closes the gas-phase refrigerant passage opening/closing valve 26a, and opens the bypass passage opening/closing valve 28a.

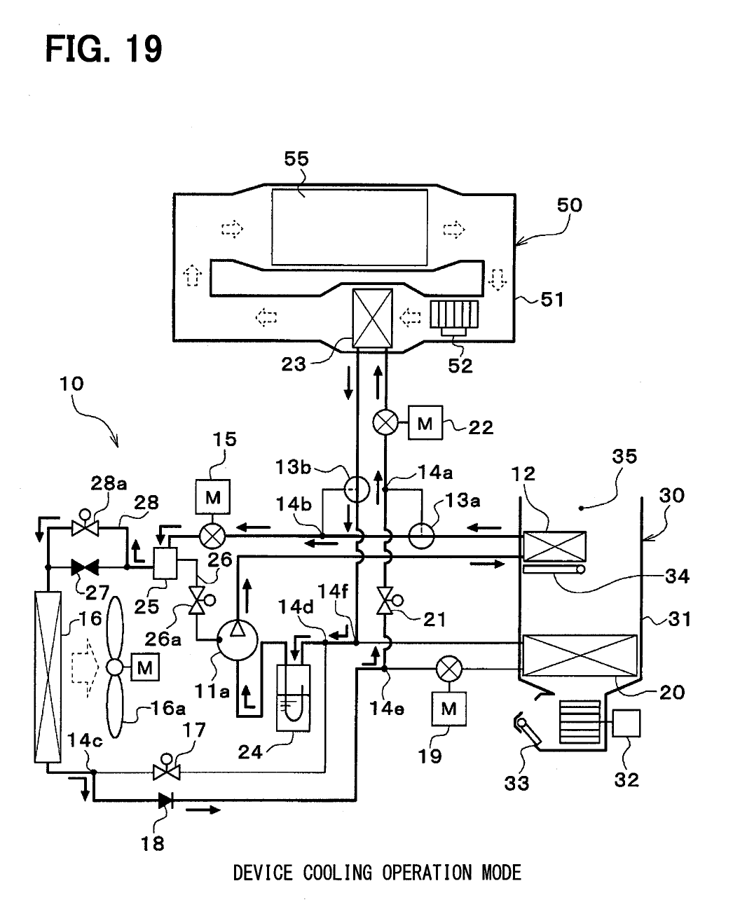

Thus, in the device cooling operation mode of this embodiment, as indicated by solid arrows of FIG. 19, the refrigeration cycle can be configured which allows for circulation of the refrigerant in the substantially same way as in the air-cooling device-cooling operation mode of the first embodiment. Thus, like the device cooling operation mode of the first embodiment, the battery ventilation air cooled by the battery heat exchanger 23 can be blown to the secondary battery 55, thereby cooling the battery.

(d) Air Heating Operation Mode

In the air heating operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24.

Further, the controller brings the air-heating expansion valve 15 into a throttle state, opens the air-heating opening/closing valve 17, completely closes the air-cooling expansion valve 19, closes the battery opening/closing valve 21, opens the gas-phase refrigerant passage opening/closing valve 26a, and closes the bypass passage opening/closing valve 28a.

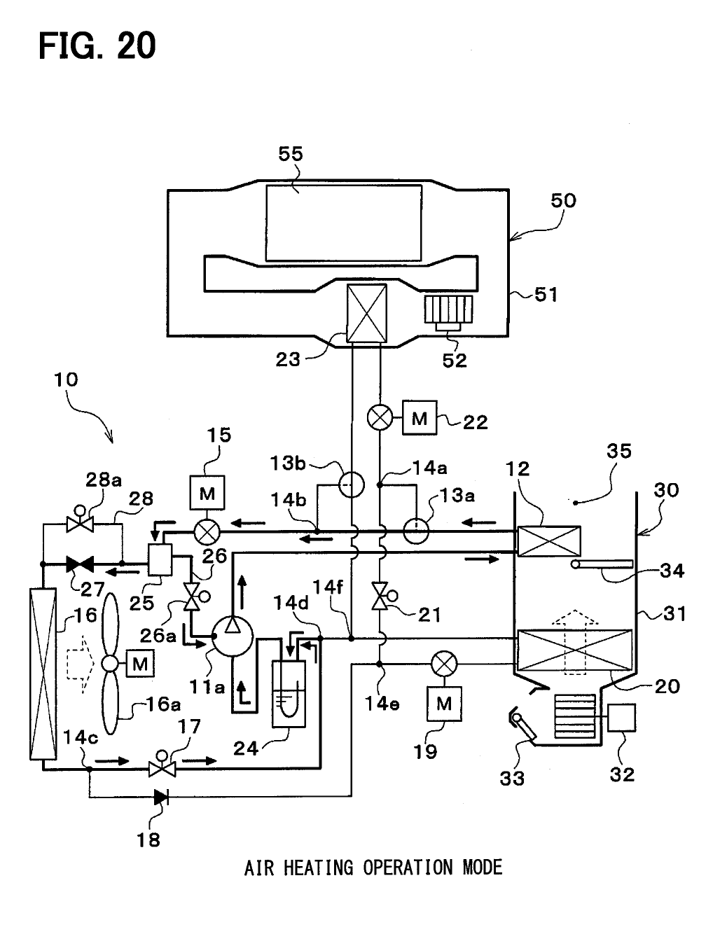

With this arrangement, in the air heating operation mode of this embodiment, as indicated by solid arrows of FIG. 20, a gas injection cycle is configured which allows the refrigerant to circulate through the compressor 11, the interior condenser 12, (the first three-way valve 13a), the air-heating expansion valve 15, the gas-liquid separator 25, the intermediate fixed throttle 27, the exterior heat exchanger 16, (the air-heating opening/closing valve 17), the accumulator 24, and the compressor 11 in this order, while drawing the intermediate-pressure gas-phase refrigerant from the gas-phase refrigerant outflow port of the gas-liquid separator 25 into the intermediate-pressure suction port of the compressor 11.

With such a refrigerant circuit structure, the controller determines the operating state of each of the various control target devices, in the same way as in the air heating operation mode of the first embodiment. Thus, in the air heating operation mode, like the first embodiment, the refrigeration cycle can be configured which allows the refrigerant dissipating its heat at the interior condenser 12 to be decompressed by the air-heating expansion valve 15 and to evaporate itself at the exterior heat exchanger 16. The interior ventilation air heated by the interior condenser 12 is blown into the vehicle interior, thereby enabling air-heating of the vehicle interior.

Further, in the air heating operation mode, the refrigeration cycle device 10a is switched to the refrigerant circuit constituting the gas injection cycle that pressurizes the refrigerant in multiple stages and merges the intermediate-pressure refrigerant generated in the cycle with the refrigerant discharged from the low-stage side compression mechanism to draw the merged refrigerant into the high-stage side compression mechanism. Thus, the mechanical efficiency (compression efficiency) of the compressor 11 can be enhanced to thereby improve the COP.

(e) Air-Heating Device-Heating Operation Mode

In the air-heating device-heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15.

Further, the controller brings the air-heating expansion valve 15 into a throttle state, opens the air-heating opening/closing valve 17, completely closes the air-cooling expansion valve 19, closes the battery opening/closing valve 21, opens the gas-phase refrigerant passage opening/closing valve 26a, and closes the bypass passage opening/closing valve 28a.

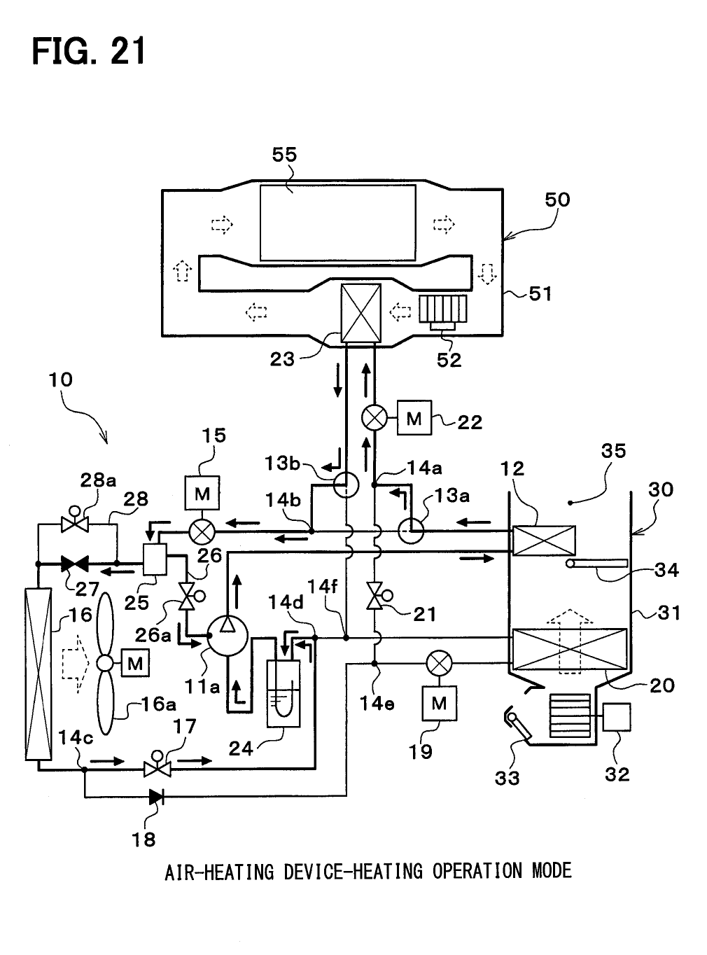

With this arrangement, in the air-heating device-heating operation mode of this embodiment, as indicated by solid arrows of FIG. 21, a gas injection cycle is configured which allows the refrigerant to circulate through the compressor 11, the interior condenser 12, (the first three-way valve 13a), the battery expansion valve 22, the battery heat exchanger 23, (the second three-way valve 13b), the air-heating expansion valve 15, the gas-liquid separator 25, the intermediate fixed throttle 27, the exterior heat exchanger 16, (the air-heating opening/closing valve 17), the accumulator 24, and the compressor 11 in this order, while drawing the intermediate-pressure gas-phase refrigerant from the gas-phase refrigerant outflow port of the gas-liquid separator 25 into the intermediate-pressure suction port of the compressor 11.

With such a refrigerant circuit structure, the controller determines the operating state of each of the various control target devices, in the same way as in the air-heating device-heating operation mode of the first embodiment. Thus, in the air-heating device-heating operation mode, like the first embodiment, the refrigeration cycle can be configured which allows the refrigerant dissipating its heat at the interior condenser 12 and the battery heat exchanger 23 to be decompressed by the air-heating expansion valve 15 and to evaporate itself at the exterior heat exchanger 16.

The interior ventilation air heated by the interior condenser 12 is blown into the vehicle compartment, thereby enabling air-heating of the vehicle interior, and the battery ventilation air heated by the battery heat exchanger 23 is blown to the secondary battery 55, thereby enabling heating of the battery. Also in the air-heating device-heating operation mode, the gas injection cycle can be configured to improve the COP.

(f) Device Heating Operation Mode

In the device heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15.

Further, the controller brings the air-heating expansion valve 15 into a throttle state, opens the air-heating opening/closing valve 17, completely closes the air-cooling expansion valve 19, closes the battery opening/closing valve 21, fully opens the battery expansion valve 22, opens the gas-phase refrigerant passage opening/closing valve 26a, and closes the bypass passage opening/closing valve 28a.

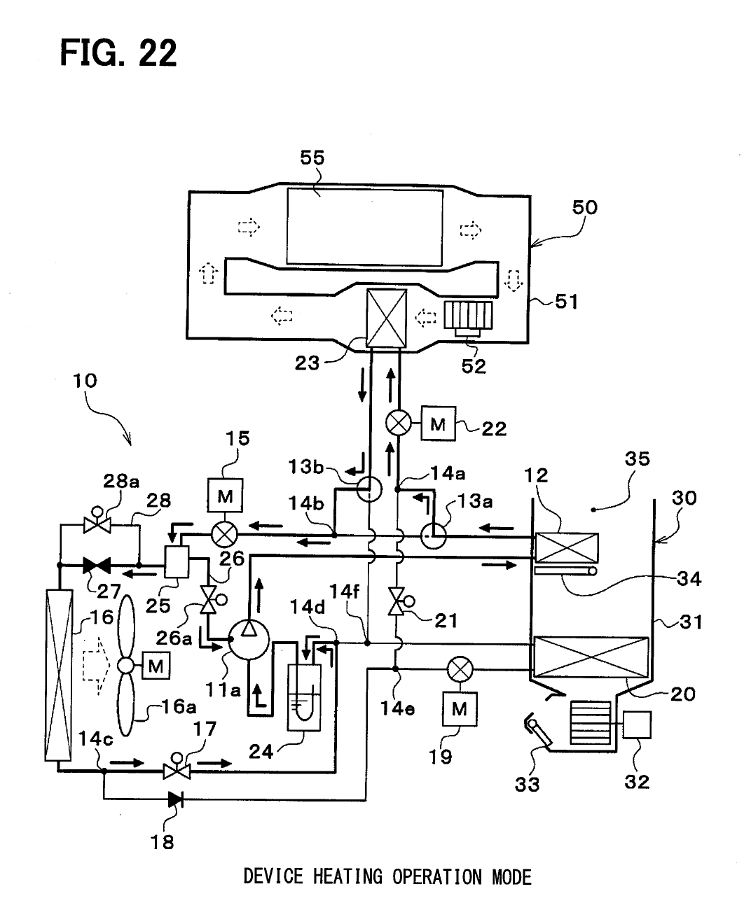

Thus, in the device heating operation mode of this embodiment, as indicated by solid arrows of FIG. 22, the refrigeration cycle device is switched to a refrigerant circuit that allows for circulation of the refrigerant in the same manner as that in the air-heating device-heating operation mode. With such a refrigerant circuit structure, the controller determines the operating state of each of the various control target devices, in the same way as in the air-heating device-heating operation mode of the first embodiment.

Thus, in the air-heating device-heating operation mode, like the first embodiment, the refrigeration cycle can be configured which allows the refrigerant dissipating its heat at the battery heat exchanger 23 to be decompressed by the air-heating expansion valve 15 and to evaporate itself at the exterior heat exchanger 16.

Further, the battery ventilation air heated by the battery heat exchanger 23 is blown to the secondary battery 55, thereby enabling heating of the battery. Also in the device heating operation mode, the gas injection cycle can be configured to improve the COP.

(g) Air-Heating Device-Cooling Operation Mode

In the air-heating device-cooling operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24.

Further, the controller brings the air-heating expansion valve 15 into a throttle state, closes the air-heating opening/closing valve 17, completely closes the air-cooling expansion valve 19, opens the battery opening/closing valve 21, brings the battery expansion valve 22 into a throttle state, opens the gas-phase refrigerant passage opening/closing valve 26a, and closes the bypass passage opening/closing valve 28a.

Thus, in the air-heating device-cooling operation mode of this embodiment, the refrigeration cycle can be configured which allows the refrigerant dissipating its heat at the interior condenser 12 to be decompressed by the air-heating expansion valve 15 and the intermediate fixed throttle 27, then evaporating itself at the exterior heat exchanger 16, and also to be decompressed by the battery expansion valve 22, then evaporating itself at the battery heat exchanger 23.

The interior ventilation air heated by the interior condenser 12 is blown into the vehicle compartment, thereby performing air-heating of the vehicle interior, and the battery ventilation air cooled by the battery heat exchanger 23 is blown to the secondary battery 55, thereby cooling the battery.

(e) Air-Cooling Device-Heating Operation Mode

In the air-cooling device-heating operation mode, the controller controls the operation of the first three-way valve 13a so as to connect the refrigerant outlet side of the interior condenser 12 to the inlet side of the battery expansion valve 22. The controller also controls the operation of the second three-way valve 13b so as to connect the refrigerant outlet side of the battery heat exchanger 23 to the inlet side of the air-heating expansion valve 15.

Further, the controller fully opens the air-heating expansion valve 15, closes the air-heating opening/closing valve 17, brings the air-cooling expansion valve 19 into a throttle state, closes the battery opening/closing valve 21, closes the gas-phase refrigerant passage opening/closing valve 26a, and opens the bypass passage opening/closing valve 28a. Thus, in the air-cooling device-heating operation mode of this embodiment, the refrigeration cycle can be configured which allows for circulation of the refrigerant in the substantially same way as in the air-cooling device-heating operation mode of the first embodiment.

Therefore, like the air-cooling device-heating operation mode of the first embodiment, the interior ventilation air cooled by the interior evaporator 20 can be blown into the vehicle compartment, thereby performing air-cooling of the vehicle interior, and the battery ventilation air heated by the battery heat exchanger 23 can be blown to the secondary battery 55, thereby heating the battery.

(i) Defrost Operation Mode

In the defrost operation mode, the controller controls the operation of the first three-way valve 13a so as to connect the refrigerant outlet side of the interior condenser 12 to the inlet side of the air-heating expansion valve 15. The controller also controls the operation of the second three-way valve 13b so as to connect the refrigerant outlet side of the battery heat exchanger 23 to the inlet side of the accumulator 24.

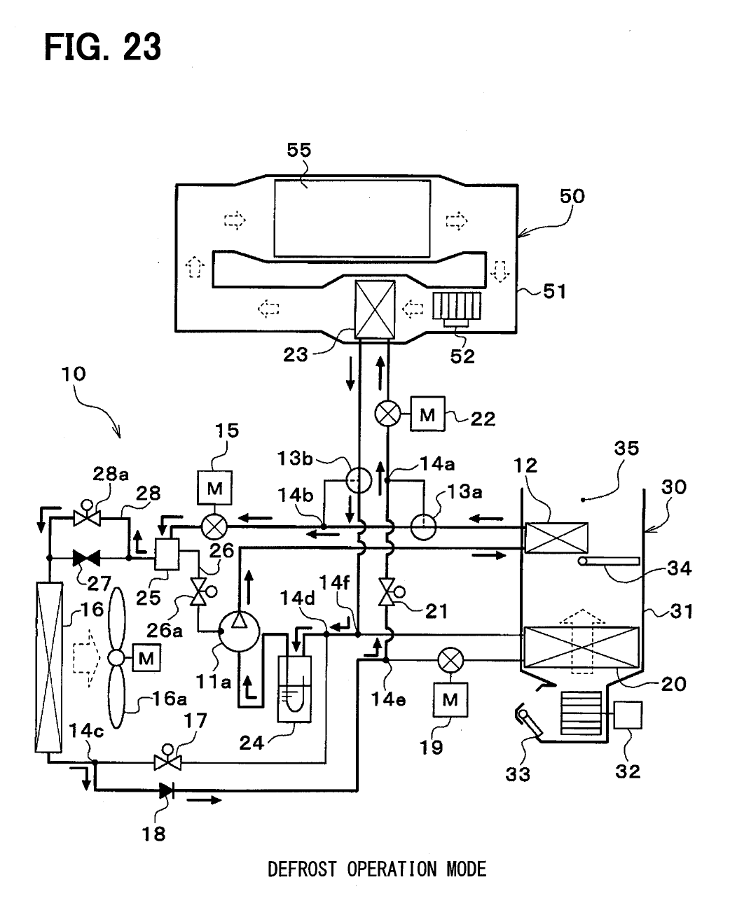

Further, the controller brings the air-heating expansion valve 15 into a throttle state, closes the air-heating opening/closing valve 17, completely closes the air-cooling expansion valve 19, opens the battery opening/closing valve 21, brings the battery expansion valve 22 into a throttle state, closes the gas-phase refrigerant passage opening/closing valve 26a, and opens the bypass passage opening/closing valve 28a. Thus, in the defrost operation mode of this embodiment, as indicated by solid arrows of FIG. 23, the refrigeration cycle can be configured which allows for circulation of the refrigerant in the substantially same way as in the defrost operation mode of the first embodiment.

Therefore, also in the defrost operation mode of this embodiment, the heat absorbed by the refrigerant from the secondary battery 55 via the battery ventilation air can be used to defrost the exterior heat exchanger 16 and to sufficiently heat the interior ventilation air at the interior condenser 12, like the defrost operation mode in the first embodiment.

### Other Embodiments

The present disclosure is not limited to the above embodiments, and various modifications and changes can be made to those embodiments in the following way without departing from the scope of the present disclosure.

(1) Although the refrigeration cycle devices 10 and 10a in the above-mentioned embodiments are applied to the electric vehicle by way of example, it is obvious that the refrigeration cycle device may be applied to hybrid vehicles that obtain a driving force for traveling produced by both the internal combustion engine and the electric motor for traveling. In application to the hybrid vehicle, a heater core designed to heat the interior ventilation air using a coolant of the internal combustion engine as a heat source may be disposed in an air passage of the interior air conditioning unit 30.

Although the interior ventilation air to be blown into the space to be air-conditioned is a fluid to be heat-exchanged in the above-mentioned embodiments by way of example, the fluid to be heat-exchanged is not limited thereto. Examples of the fluid to be heat-exchanged may include a coolant for the internal combustion engine, intake air supplied to the internal combustion engine, coolants for an electric motor, an inverter, a transmission, an engine catalyst, etc.

(2) Although the above-mentioned embodiments employ the first and second three-way valves 13a and 13b and the like as the refrigerant circuit switching portion for the refrigeration cycle devices 10 and 10a by way of example, the refrigerant circuit switching portion is not limited thereto. For example, in place of the first and second three-way valves 13a and 13b, a combination of three electromagnetic valves may constitute the refrigerant circuit switching portion.

In the above-mentioned embodiments, the variable throttle mechanism with the fully opening function is employed as the air-heating expansion valve 15 by way of example. Alternatively, a decompression device (including a fixed throttle) for an exterior device without having the fully opening function may be employed as the air-heating expansion valve 15. In this case, a bypass passage may be provided for bypassing the decompression device for the exterior device, and an opening/closing valve having the same structure as that of the air-heating opening/closing valve 17 or the like may be disposed in the bypass passage so as to act as the refrigerant flow path switch.

In the above-mentioned embodiments, the variable throttle mechanism with the completely closing function is employed as the air-cooling expansion valve 19 by way of example. Alternatively, an air-cooling decompression device (including a fixed throttle) without having the completely closing function may be employed as the air-cooling expansion valve 19. In this case, the opening/closing valve having the same structure as that of the air-heating opening/closing valve 17 or the like may be arranged in series to the air-cooling decompression device so as to act as the refrigerant flow path switch.

The sixth embodiment has described the example of embodying the fixed-throttle bypass passage 28 and the bypass passage opening/closing valve 28a. Alternatively, in place of the bypass passage opening/closing valve 28a, the refrigeration cycle device may employ an electric three-way valve that switches between a refrigerant circuit for connection between the liquid-phase refrigerant outflow port of the gas-liquid separator 25 and the inlet side of the intermediate fixed throttle 27, and another refrigerant circuit for connection between the liquid-phase refrigerant outflow port of the gas-liquid separator 25 and the inlet side of the fixed-throttle bypass passage 28.

(3) In the above-mentioned embodiment, the frost formation determining portion determines that frost is formed on the exterior heat exchanger 16 when the exterior device temperature Ts is equal to or less than the reference frost formation temperature Tks (e.g., −10° C.). However, the frost formation determining portion is not limited thereto. For example, when a time period during which the exterior device temperature Ts is equal to or lower than the reference frost formation temperature Tks (e.g., 0° C.) exceeds a predetermined time (e.g., 5 minutes), the exterior heat exchanger 16 may be determined to have frost formed thereon.

(4) In the above-mentioned embodiments, in the operation modes of not cooling or heating the secondary battery 55 (specifically, in an air cooling operation mode (a) and in the air heating operation mode (d)), the operation of the blower 52 in the battery pack 50 is stopped by way of example. However, since the temperature distribution tends to occur in the secondary battery 55 as mentioned above, the blower 52 may be operated in these operation modes. Thus, the battery ventilation air is allowed to circulate through the battery pack 50, thereby enabling suppression of the temperature distribution in the secondary battery 55.

(5) Although in the above-mentioned embodiments, the temperature detector for detecting the battery temperature Tb is the temperature sensor that detects the temperature of a main body of the secondary battery 55 by way of example, the temperature detector is not limited thereto. For example, the first embodiment may employ a temperature detector for detecting the temperature of the ventilation air for the battery provided directly after passing through the secondary battery 55. Alternatively, the second embodiment may employ a temperature detector that detects the temperature of the heat medium directly after it passes through the secondary battery 55.

(6) The structures disclosed in the above respective embodiments may be appropriately combined within the feasible range. For example, the refrigeration cycle device 10a described in the sixth embodiment may be operated in accordance with the time chart shown in FIG. 11 described in the second embodiment. In the refrigeration cycle device 10a, the heat medium circuit 50a described in the fourth embodiment may be applied. As mentioned in the fifth embodiment, the refrigerant flowing out of the battery expansion valve 22 may directly cool or heat the secondary battery 55.

(7) In the refrigeration cycle device 10 of the first embodiment described above, the interior condenser 12 exchanges heat between the high-pressure refrigerant and the ventilation air, thereby heating the ventilation air by way of example. However, the structure for heating the ventilation air is not limited thereto.

For example, a heat medium circulation circuit may be provided which has the same structure as that of the heat medium circuit 50a described in the fourth embodiment. Further, the heat medium circulation circuit may be provided with a water-refrigerant heat exchanger that exchanges heat between the heat medium and the high-pressure refrigerant discharged from the compressor 11. A heat exchanger may be provided to exchange heat between the ventilation air and the heat medium heated by the water-refrigerant heat exchanger, thereby heating the ventilation air. Moreover, the heat exchanger may be used to heat the interior ventilation air, in place of the interior condenser 12.

That is, the interior ventilation air may be indirectly heated via the heat medium using the high-pressure refrigerant discharged from the compressor 11 as a heat source. Further, in applying the refrigeration cycle device to the vehicle with the internal combustion engine, the coolant of the internal combustion engine may circulate as the heat medium through the heat medium circulation circuit. In the electric vehicle, a coolant for cooling a battery or an electric device may circulate as the heat medium through the heat medium circulation circuit.

1. A refrigeration cycle device comprising:
a compressor that compresses and discharges a refrigerant;
a heating heat exchanger that exchanges heat between a fluid to be heat-exchanged and the refrigerant discharged from the compressor to heat the fluid to be heat-exchanged;
an exterior heat exchanger that exchanges heat between the refrigerant and outside air;
an exterior-device decompression device that decompresses the refrigerant to flow into the exterior heat exchanger;
a battery heat exchanger that exchanges heat between a battery and either one of the refrigerant discharged from the compressor and the refrigerant flowing out of the exterior heat exchanger to adjust a battery temperature of the battery;
a battery decompression device that decompresses the refrigerant to flow into the battery heat exchanger; and
a refrigerant circuit switching portion that switches a refrigerant circuit for the refrigerant circulating through a cycle, wherein
the refrigerant circuit switching portion switches to
a refrigerant circuit in which the refrigerant dissipating heat at least in the heating heat exchanger is decompressed by the exterior-device decompression device and is evaporated at the exterior heat exchanger, in a fluid heating operation for heating the fluid to be heat-exchanged, and
another refrigerant circuit in which the refrigerant dissipating heat in the heating heat exchanger and the exterior heat exchanger is decompressed by the battery decompression device, and is evaporated at the battery heat exchanger, in a defrost operation for defrosting the exterior heat exchanger.

2. The refrigeration cycle device according to claim 1, wherein
the refrigerant circuit switching portion switches to a refrigerant circuit in which the refrigerant dissipating heat at the heating heat exchanger is decompressed by the exterior-device decompression device to flow into the exterior heat exchanger, and the refrigerant dissipating heat at the exterior heat exchanger is decompressed by the battery decompression device to evaporate at the battery heat exchanger, in the defrost operation.

3. The refrigeration cycle device according to claim 1, wherein
the refrigerant circuit switching portion switches to a refrigerant circuit in which the refrigerant discharged from the compressor dissipates heat at the battery heat exchanger, in a battery heating operation for heating the battery.

4. The refrigeration cycle device according to claim 3, further comprising:
a frost formation determining portion that determines whether frost is formed on the exterior heat exchanger; and
a refrigerant circuit controller that controls an operation of the refrigerant circuit switching portion, wherein
the refrigerant circuit controller controls the operation of the refrigerant circuit switching portion to be switched to the refrigerant circuit in the defrost operation, when the frost formation determining portion determines that frost is formed on the exterior heat exchanger, and
the refrigerant circuit controller controls the operation of the refrigerant circuit switching portion to set the battery temperature to a predetermined reference warm-up temperature or higher, when the frost formation determining portion determines that frost is not formed on the exterior heat exchanger.

5. The refrigeration cycle device according to claim 4, wherein
the refrigerant circuit controller controls an operation of the refrigerant circuit switching portion to be switched to the refrigerant circuit in the battery heating operation, when another refrigerant circuit is switched from the refrigerant circuit in the defrost operation.
